(19) United States
(12) Patent Application Publication
(10) Pub. No.: US 2023/0291493 A1
(43) Pub. Date: Sep. 14, 2023

(54) Wavelength-Multiplexed Optical Source with Reduced Temperature Sensitivity

(71) Applicant: Ayar Labs, Inc., Santa Clara, CA (US)

(72) Inventors: Manan Raval, Oakland, CA (US); Matthew Sysak, Sunnyvale, CA (US); Judson Ryckman, Santa Clara, CA (US); Sidney Buchbinder, Santa Clara, CA (US)

(21) Appl. No.: 18/180,100

(22) Filed: Mar. 7, 2023

Related U.S. Application Data
(60) Provisional application No. 63/318,054, filed on Mar. 9, 2022.

(51) Int. Cl. H04J 14/02; H04Q 11/00

(52) U.S. Cl. CPC H04J 14/0282; H04Q 11/0067

(57) ABSTRACT

An optical distribution network includes a fore-positioned optical multiplexer section that has a plurality of optical inputs and a plurality of intermediate optical outputs. Each of the plurality of optical inputs of the fore-positioned optical multiplexer section receives a respective one of a plurality of input light signals of different wavelengths. The fore-positioned optical multiplexer section multiplexes a unique subset of the plurality of input light signals onto each of the plurality of intermediate optical outputs. The optical distribution network also includes an optical coupler section that has a plurality of optical inputs respectively optically connected to the plurality of intermediate optical outputs of the fore-positioned optical multiplexer section. The optical coupler section distributes a portion of each light signal received at each of the plurality of optical inputs of the optical coupler section to each and every one of a plurality of optical outputs of the optical coupler section.

### CROSS-REFERENCE TO RELATED APPLICATION

This claims priority under 35 U.S.C. 119(e) to U.S. Provisional Patent Application No. 63/318,054, filed on Mar. 9, 2022, the disclosure of which is incorporated herein by reference in its entirety for all purposes.

### BACKGROUND OF THE INVENTION

The embodiments disclosed herein relate to optical data communication. Optical data communication systems operate by modulating laser light to encode digital data patterns. The modulated laser light is transmitted through an optical data network from a sending node to a receiving node. The modulated laser light having arrived at the receiving node is de-modulated to obtain the original digital data patterns. Therefore, implementation and operation of optical data communication systems is dependent upon having reliable and efficient laser light sources. Also, it is desirable for the laser light sources of optical data communication systems to have a minimal form factor and be designed as efficiently as possible with regard to expense and energy consumption. It is within this context that the present disclosed embodiments arise.

### SUMMARY OF THE INVENTION

In an example embodiment, an optical distribution network is disclosed. The optical distribution network includes a fore-positioned optical multiplexer section that has a plurality of optical inputs and a plurality of intermediate optical outputs. Each of the plurality of optical inputs of the fore-positioned optical multiplexer section is configured to receive a respective one of a plurality of input light signals of different wavelengths. The fore-positioned optical multiplexer section is configured to multiplex a unique subset of the plurality of input light signals onto each of the plurality of intermediate optical outputs. The unique subset of the plurality of input light signals that is multiplexed on any given one of the plurality of intermediate optical outputs is mutually exclusive with respect to the plurality of input light signals that are multiplexed on others of the plurality of intermediate optical outputs. The optical distribution network also includes an optical coupler section that has a plurality of optical inputs respectively optically connected to the plurality of intermediate optical outputs of the fore-positioned optical multiplexer section. The optical coupler section has a plurality of optical outputs that correspond to a plurality of optical outputs of the optical distribution network. The optical coupler section is configured to distribute a portion of each light signal received at each of the plurality of optical inputs of the optical coupler section to each and every one of the plurality of optical outputs of the optical coupler section.

In an example embodiment, a laser module is disclosed. The laser module includes a laser array that includes a plurality of lasers. Each laser of the plurality of lasers is configured to generate and output a different one of a plurality of wavelengths of continuous wave laser light. The plurality of lasers are arranged in the laser array such that a sequence of the plurality of wavelengths of continuous wave laser light is non-monotonically ordered across the laser array. The laser module also includes an optical distribution network that includes a fore-positioned optical multiplexer section and an optical coupler section that is disposed after the fore-positioned optical multiplexer section with respect to a light propagation direction through the optical distribution network. The fore-positioned optical multiplexer section has a plurality of optical inputs that are optically connected to the plurality of lasers, such that the non-monotonic ordering of the sequence of the plurality of wavelengths of continuous wave laser light across the laser array matches an ordering of wavelength acceptance passbands of the plurality of optical inputs of the fore-positioned optical multiplexer section. The fore-positioned optical multiplexer section has a plurality of intermediate optical outputs. The fore-positioned optical multiplexer section is configured to multiplex a unique and mutually exclusive subset of the plurality of wavelengths of continuous wave laser light onto each of the plurality of intermediate optical outputs. The optical coupler section has a plurality of optical inputs respectively optically connected to the plurality of intermediate optical outputs of the fore-positioned optical multiplexer section. The optical coupler section has a plurality of optical outputs respectively corresponding to each of a plurality of optical outputs of the optical distribution network and a plurality of outputs of the laser module. The optical coupler section is configured to distribute a portion of each light signal received at each of the plurality of optical inputs of the optical coupler section to each and every one of the plurality of optical outputs of the optical coupler section.

A method is disclosed for operating a laser module. The method includes operating a plurality of lasers to respectively generate a plurality of input light signals of different wavelengths. The method also includes conveying the plurality of input light signals to a plurality of optical inputs of a fore-positioned optical multiplexer section, such that each of the plurality of optical inputs of the fore-positioned optical multiplexer section receives a respective one of the plurality of input light signals of different wavelengths. The method also includes operating the fore-positioned optical multiplexer section to multiplex a unique subset of the plurality of input light signals onto each of a plurality of intermediate optical outputs, such that the unique subset of the plurality of input light signals that is multiplexed on any given one of the plurality of intermediate optical outputs is mutually exclusive with respect to the plurality of input light signals that are multiplexed on others of the plurality of intermediate optical outputs. The method also includes conveying the unique subsets of the plurality of input light signals from the plurality of intermediate optical outputs to a plurality of optical inputs of an optical coupler section, such that a different unique subset of the plurality of input light signals is respectively conveyed to each of the plurality of optical inputs of an optical coupler section. The method also includes operating the optical coupler section to distribute a portion of each light signal that is received at each of the plurality of optical inputs of the optical coupler section to each and every one of a plurality of optical outputs of the optical coupler section.

### BRIEF DESCRIPTION OF THE DRAWINGS

FIG. 1A shows an example implementation of an optical power supply for an optical data communication system, in accordance with some embodiments.

FIG. 1B shows a diagram indicating how each of the optical fibers of the N-port optical fiber array receives each of the multiple wavelengths (λ₁ to λ_{M}) of CW laser light, in accordance with some embodiments.

FIG. 2A shows an example of an M×1 cascaded MUX network, in accordance with some embodiments.

FIG. 2B shows the relative intensities of the CW laser light of the different light wavelengths λ₁, λ₂, λ₃, λ₄, λ₅, λ₆, λ₇, and λ₈ as output from the 8×1 cascaded MUX network, in accordance with some embodiments.

FIG. 2C shows the M×1 cascaded MUX network, where M=8, optically connected to the laser array, in accordance with some embodiments.

FIG. 2D shows input port light wavelength acceptance passbands of the MZI's (MUX's) in the first MZI stage, the MZI's (MUX's) in the second MZI stage, and the MZI (MUX) in the third MZI stage, in accordance with some embodiments.

FIG. 3 shows an example architecture of an M×N optical distribution network having M optical inputs and N optical outputs, where N is less than M, in accordance with some embodiments.

FIG. 4A shows an 8×4 optical distribution network that is an example implementation of the M×N optical distribution network of FIG. 3, in accordance with some embodiments.

FIG. 4B shows the relative intensities of the CW laser light of the different light wavelengths λ₁, λ₂, λ₃, λ₄, λ₅, λ₆, λ₇, and λ₈ as output from the 8×4 optical distribution network of FIG. 4A, in accordance with some embodiments.

FIG. 4C shows the 8×4 optical distribution network of FIG. 4A optically connected to the laser array, in accordance with some embodiments.

FIG. 5A shows a system in which the laser array is directly coupled to the M×N optical distribution network of FIG. 3 to form a laser module, in accordance with some embodiments.

FIG. 5B shows the diagram of FIG. 5A with the M×N optical distribution network depicted in detail, in accordance with some embodiments.

FIG. 6A shows a system in which the laser array is directly coupled to an 8×8 optical distribution network, in accordance with some embodiments.

FIG. 6B shows the relative intensities of the CW laser light of the different light wavelengths λ₁, λ₂, λ₃, λ₄, λ₅, λ₆, λ₇, and λ₈ as provided to the inputs of the 8×8 optical distribution network and as output through the outputs of the 8×8 optical distribution network, in accordance with some embodiments.

FIG. 7 shows a flowchart of a method for operating a laser module, in accordance with some embodiments.

### DETAILED DESCRIPTION OF THE INVENTION

In the following description, numerous specific details are set forth in order to provide an understanding of the embodiments disclosed herein. It will be apparent, however, to one skilled in the art that the embodiments disclosed herein may be practiced without some or all of these specific details. In other instances, well known process operations have not been described in detail in order not to unnecessarily obscure the disclosed embodiments.

High bandwidth, multi-wavelength WDM (Wavelength-Division Multiplexing) systems are used to meet the needs of increasing interconnect bandwidth requirements. In some implementations of these WDM systems, a remote laser array that outputs multiple wavelengths of continuous wave (CW) laser light is combined with an optical distribution network to transmit optical power at multiple wavelengths across multiple optical output ports. In some embodiments, a number N of optical output ports is less than a number M of optical input ports at some point in the optical train, which necessitates implementation of optical multiplexer (MUX) functionality. In some embodiments, arrayed waveguide gratings or cascaded Mach-Zehnder interferometers are used to combine (multiplex) multiple (M) wavelengths of light into one optical channel, where this one optical channel is then combined with a 1×N optical splitter to realize an M×N optical distribution network. However, an M×1 optical MUX requires optical filtering with passbands that are bandwidth-limited by the light wavelength spacing, which can in turn result in undesired temperature sensitivity. Example embodiments are disclosed herein for an M optical input by N optical output (M×N) optical (light) distribution network (for N less than M) that uses a reduced number of optical MUX stages (as compared to an M×1 cascaded optical MUX network) in combination with a star coupler at the output. In comparison to using an M×1 optical MUX system followed by 1×N optical splitting, the M×N optical distribution network disclosed herein enables lower temperature sensitivity by allowing for wider optical MUX passbands.

Also, for a cascaded optical MUX network, the required sequence of input light wavelengths is typically not increasing or decreasing in order of the input channel. Rather, the sequence of input light wavelengths is a non-monotonic sequence that has to match the input light wavelength passbands of the first optical MUX stage. In various example embodiments disclosed herein, the light wavelength sequence on the laser array is configured to match the input light wavelength passbands of the first optical MUX stage to enable direct one-to-one coupling of the lasers in the laser array with the input channels of the optical distribution network without the need for any additional optical routing or crossings. It should be understood that the light wavelength sequence on the laser array is the order in which the different laser wavelengths occur from laser-to-adjacently positioned laser in a single direction across the laser array.

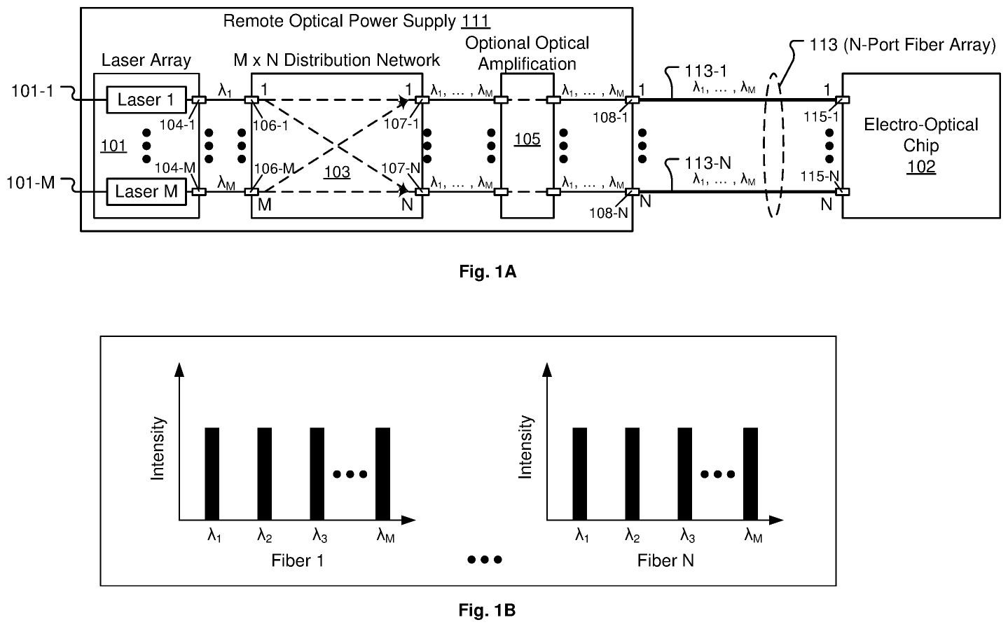

FIG. 1A shows an example implementation of an optical power supply 111 for an optical data communication system, in accordance with some embodiments. The optical power supply 111 includes a laser array 101, an M×N optical distribution network 103, and an optional optical amplification module 105. The laser array 101 includes a number (M) of lasers 101-1 to 101-M, where M is greater than one. Each laser 101-1 to 101-M is configured to generate and output CW laser light of a different wavelength (a respective one of λ₁ to λ_{M}) to a respective optical output 104-1 to 104-M of the laser array 101. The M wavelengths (λ₁ to λ_{M}) of CW laser light are conveyed from the optical outputs 104-1 to 104-M of the laser array 101 to respective optical inputs 106-1 to 106-M of the M×N optical distribution network 103. The optical distribution network 103 routes the CW laser light at each of the M wavelengths, as generated by the multiple lasers 101-1 through 101-M, to each of a number (N) of optical output ports 107-1 to 107-N of the optical distribution network 103. In some embodiments, the optional optical amplification module 105 is not present and the multiple wavelengths (λ₁ to λ_{M}) of CW laser light that are directed to a given one 107-x (where x is any one of 1 to N) of the N optical output ports 107-1 to 107-N of the optical distribution network 103 are transmitted directly to a corresponding one 108-x of N optical outputs 108-1 to 108-N of the optical power supply 111, and in turn into a corresponding one 113-x of N optical fibers 113-1 to 113-N of an N-port optical fiber array 113. In some embodiments, the optional optical amplification module 105 is present and the multiple wavelengths (λ₁ to λ_{M}) of CW laser light that are directed to a given one 107-x of the N optical output ports 107-1 to 107-N of the optical distribution network 103 are transmitted through the optical amplification module 105 for amplification in route to a corresponding one 108-x of the N optical outputs 108-1 to 108-N of the optical power supply 111, and in turn into a corresponding one 113-x of the N optical fibers 113-1 to 113-N of the N-port optical fiber array 113, where x is an integer from 1 to N. In this manner, the optical power supply 111 operates to provide multiple wavelengths (λ₁ to λ_{M}) of CW laser light on each of the N optical fibers 113-1 to 113-N of the N-port optical fiber array 113.

In some embodiments, each of the optical fibers 113-1 to 113-N of the N-port optical fiber array 113 is connected to route the multiple wavelengths (λ₁ to λ_{M}) of CW laser light that it receives from the optical power supply 111 to a corresponding optical supply port 115-1 to 115-N on an electro-optical chip 102. In this manner, the N-port optical fiber array 113 delivers the M wavelengths (λ₁ to λ_{M}) of CW laser light to each of N optical supply ports 115-1 to 115-N on the electro-optical chip 102. In some embodiments, the electro-optical chip 102 is a CMOS (Complementary Metal Oxide Semiconductor) and/or an SOI (silicon-on-insulator) photonic/electronic chip, that sends and receives data in an optical data communication system. In some embodiments, the electro-optical chip 102 is the TeraPHY™ chip produced by Ayar Labs, Inc., of Santa Clara, Calif., as described in U.S. patent application Ser. No. 17/184,537, which is incorporated herein by reference in its entirety for all purposes.

FIG. 1B shows a diagram indicating how each of the optical fibers 113-1 to 113-N of the N-port optical fiber array 113 receives each of the multiple wavelengths (λ₁ to λ_{M}) of CW laser light, in accordance with some embodiments. In some embodiments, each of the multiple wavelengths (λ₁ to λ_{M}) of CW laser light is conveyed through each of the optical fibers 113-1 to 113-N of the N-port optical fiber array 113 at a substantially equal intensity (optical power level). The laser array 101 includes the number M of CW light output channels, where each of the M laser output channels has a unique light wavelength (a unique one of λ₁ to λ_{M}). The optical (light) distribution network 103 is implemented to distribute optical power from each of the M laser output channels of the laser array 101 to each of the number N of optical output ports 107-1 to 107-N of the optical distribution network 103.

In some embodiments, for the M×N optical distribution network 103 where the number N of optical output ports 107-1 to 107-N is less than the number M of CW light output channels of the laser array 101, the M×N optical distribution network 103 includes at least one stage of optical wavelength multiplexers (MUX's). In some embodiments, optical wavelength multiplexing is implemented by using a series of cascaded Mach-Zehnder interferometers (MZIs), where each MZI is capable of combining two wavelengths of light incident on the two MZI input ports onto one of the MZI output ports. In some embodiments, a cascaded MZI system is used to realize M×1 multiplexing, where M=2ⁿ and n is an integer. In this type of cascaded MZI system, the final MZI stage of the cascaded MZI system has a free spectral range (FSR) approximately equal to the light wavelength spacing, where the MZI FSR is doubled in each preceding stage of the cascaded MZI system. In some embodiments, this type of cascaded MZI system is used to implement WDM in an optical data communication application. The MZI in the above-mentioned cascaded MZI system serves as a light wavelength MUX. However, in various embodiments, it is not necessary to use an MZI as the MUX in the M×N optical distribution network 103. For example, in some embodiments, instead of the using the MZI as the MUX device, the M×N optical distribution network 103 can be implemented using essentially any other type of optical MUX device, such as a ring-based add-drop filter, a grating-based add-drop filter, a directional coupler, and/or an integrated dichroic filter, among others, by way of example.

For the M×N optical distribution network 103 that implements a cascaded MUX network, the light wavelength sequence of the optical input ports 106-1 to 106-M may not be monotonically increasing or decreasing, and the light wavelength sequence of the optical input ports 106-1 to 106-M should be adjusted to match the acceptable light wavelength passbands of the MUX devices. For example, when using MZI's as the MUX's in the M×N optical distribution network 103, the first MZI stage has an FSR that is equal to the light wavelength spacing multiplied by M and a half-FSR shift in the transmission function of the two input ports of the first MZI stage. Therefore, the two light wavelengths entering the two input ports of each MZI are chosen such that the two light wavelengths are separated by the wavelength spacing multiplied by M/2. Therefore, to enable one-to-one coupling of each physical laser channel of the laser array 101 to the corresponding physical input channel (106-1 to 106-N) of the cascaded MUX network within the M×N optical distribution network 103, embodiments are disclosed herein for a modification of the optical power supply 111 in which the light wavelength sequence of the laser array 101 is configured to satisfy the input light wavelength passband sequence requirements of the cascaded MUX network within the M×N optical distribution network 103.

In order to directly use the above-described cascaded MUX network to implement the M×N optical distribution network 103, a 1×N optical power splitter is positioned after the M×1 MUX. One drawback of this approach is that the final MUX stage in the M×1 wavelength optical combiner requires an acceptance passband that is substantially narrower than the light wavelength spacing. Since the spectral response of any material with a non-zero thermo-optic coefficient will shift with temperature, a narrower light wavelength passband will lead to increased temperature sensitivity in the insertion loss of the M×N optical distribution network 103. For example, in an MZI-based 8×1 optical combiner, the final MZI should have an FSR that is approximately equal to the light wavelength spacing, which will result in a light wavelength passband that is substantially narrower than the light wavelength spacing. If the peaks of the light wavelength passbands of the MUX's (e.g., MZI's) in the first MUX (MZI) stage are nominally aligned with the input light wavelengths of the lasers, a shift in the peaks of the light wavelength passbands of the MUX's (e.g., MZI's) in the first MUX (MZI) stage due to a shift in the temperature will result in a decrease in the output optical power of the M×N optical distribution network 103.

Embodiments are disclosed herein for an M×N optical distribution network (with N less than M) in which the number of MUX stages is reduced as compared to a M×1 optical distribution network. Also, in various embodiments, the M×N optical distribution network disclosed herein includes an optical star coupler implemented to distribute light from a number of intermediate optical outputs of a reduced MUX front-end network to the N optical output ports of the M×N optical distribution network. In these embodiments, the reduced MUX front-end network refers to an M×O front-end network, where O is greater than 1, and where O is less than or equal to N (1<O≤N), and where each of the O output ports of the M×O front-end network conveys a unique set of light wavelengths. In these embodiments, an O×N star coupler is optically connected to the O output ports of the M×O front-end network to complete formation of the M×N optical distribution network, where each of the N optical outputs of the M×N optical distribution network conveys all M of the CW laser light input wavelengths. In comparison with the M×N optical distribution network implemented using the M×1 cascaded MUX network followed by the 1×N network, the M×N optical distribution network implemented using the M×O front-end network followed by the O×N star coupler provides for lower optical insertion loss because it is implemented using fewer functional stages, which corresponds to fewer optical components per pathway in order to realize M×N CW laser light distribution functionality. Also, in comparison with the M×N optical distribution network implemented using the M×1 cascaded MUX network followed by the 1×N network, the M×N optical distribution network implemented using the M×O front-end network followed by the O×N star coupler provides for decreased temperature sensitivity because the fore-positioned MUX stages have a broader FSR and can therefore support a broader CW laser light input wavelength passband. A broader CW laser light input wavelength passband will provide for lower optical insertion loss variation if the MUX spectrum shifts due to changes in temperature.

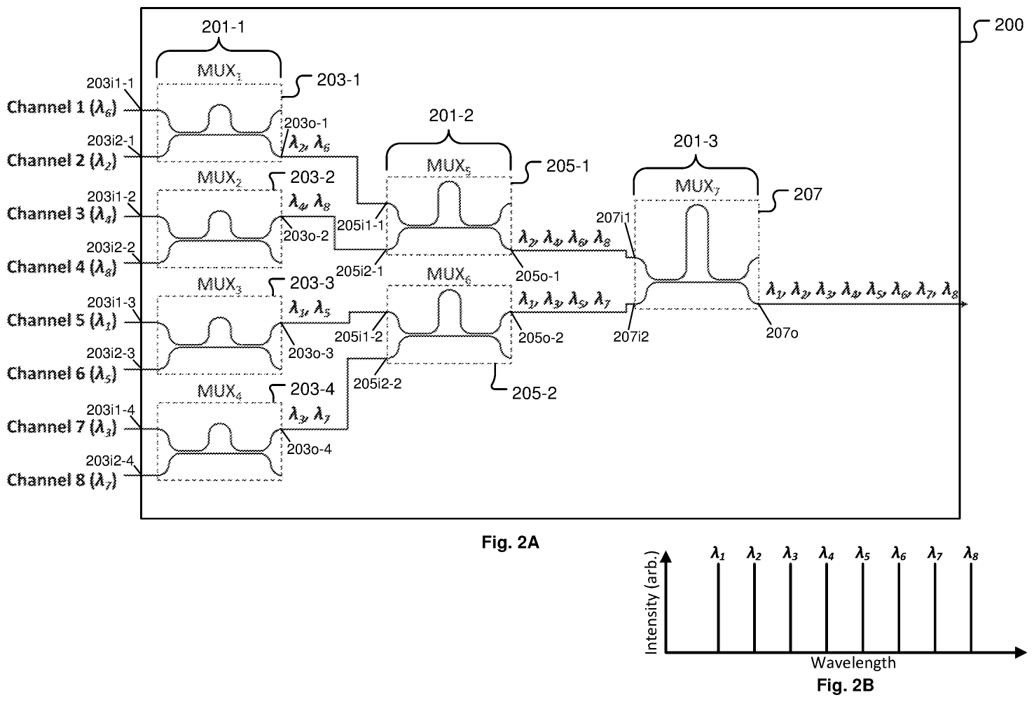

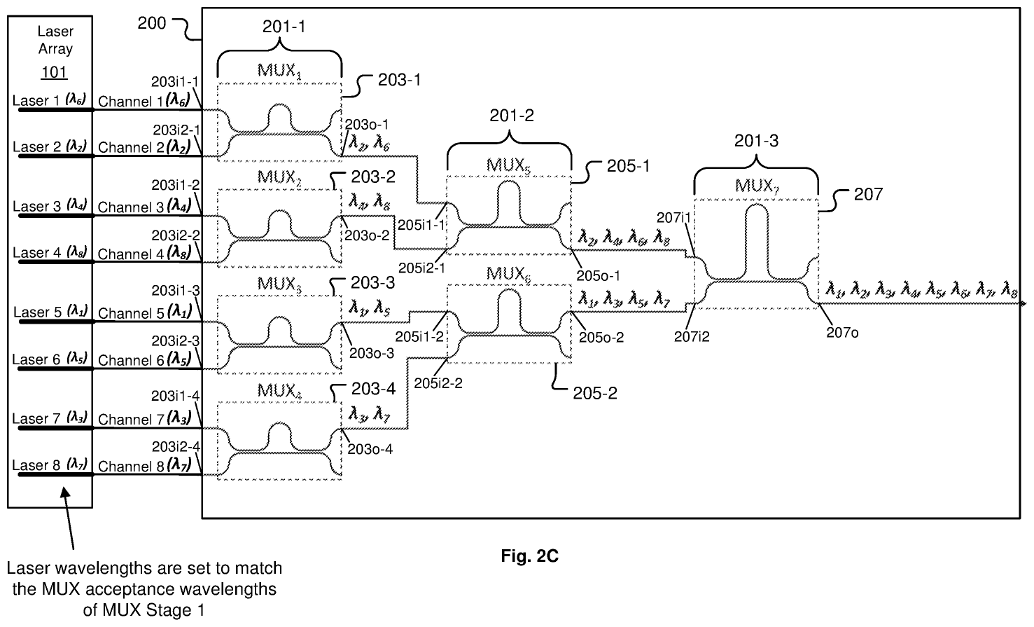

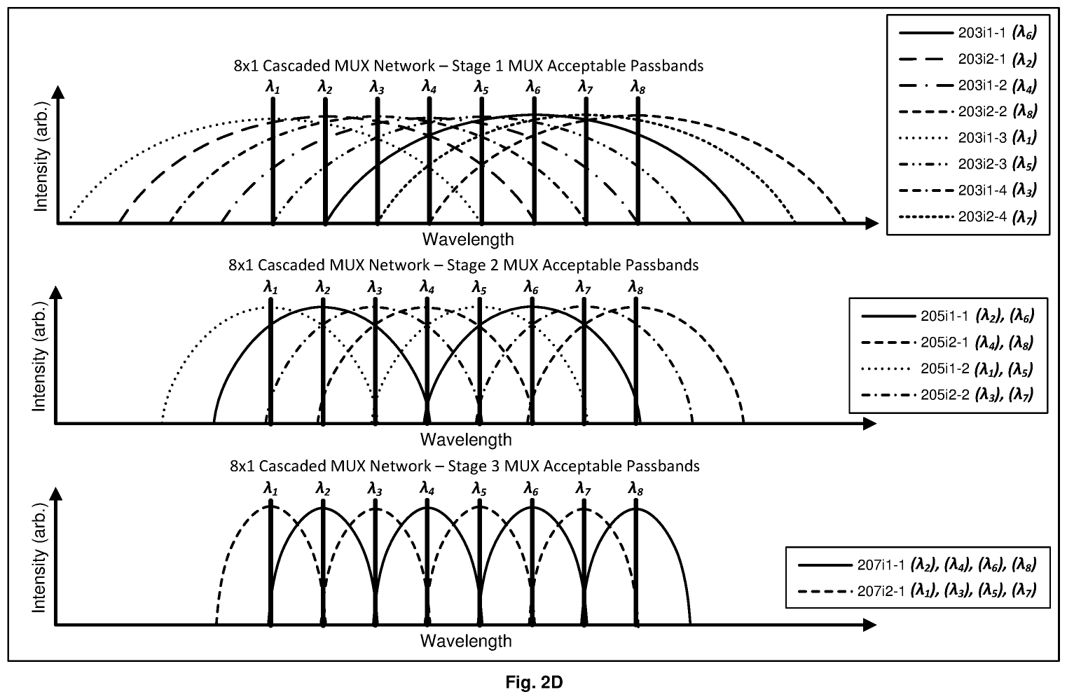

FIG. 2A shows an example of an M×1 cascaded MUX network 200, in accordance with some embodiments. Specifically, FIG. 2A shows an 8×1 wavelength combiner based on cascaded MZI stages 201-1, 201-2, 201-3. The MZI stage 201-1 includes four MZI's 203-1, 203-2, 203-3, 203-4. The MZI stage 201-2 includes two MZI's 205-1 and 205-2. The MZI stage 201-3 includes one MZI 207. Each of the MZI's 203-1, 203-2, 203-3, 203-4, 205-1, 205-2, and 207 functions as a 2-to-1 optical multiplexer (MUX). In this manner, the 8×1 cascaded MUX network 200 includes seven 2-to-1 optical multiplexers MUX₁, MUX₂, MUX₃, MUX₄, MUX₅, MUX₆, and MUX₇ in the form of MZI's 203-1, 203-2, 203-3, 203-4, 205-1, 205-2, and 207, respectively.

The MZI 203-1 has two optical inputs 203i1-1 and 203i2-1 that receive CW laser light input wavelengths λ₆ and λ₂, respectively. The two optical inputs 203i1-1 and 203i2-1 correspond to input channels 1 and 2 of the M×1 cascaded MUX network 200, respectively. The MZI 203-1 has an optical output 203o-1. The MZI 203-1 is configured to combine the two CW laser light input wavelengths λ₆ and λ₂ onto the one optical output 203o-1.

The MZI 203-2 has two optical inputs 203i1-2 and 203i2-2 that receive CW laser light input wavelengths λ₄ and λ₈, respectively. The two optical inputs 203i1-2 and 203i2-2 correspond to input channels 3 and 4 of the M×1 cascaded MUX network 200, respectively. The MZI 203-2 has an optical output 203o-2. The MZI 203-2 is configured to combine the two CW laser light input wavelengths λ₄ and λ₈ onto the one optical output 203o-2.

The MZI 203-3 has two optical inputs 203i1-3 and 203i2-3 that receive CW laser light input wavelengths λ₁ and λ₅, respectively. The two optical inputs 203i1-3 and 203i2-3 correspond to input channels 5 and 6 of the M×1 cascaded MUX network 200, respectively. The MZI 203-3 has an optical output 203o-3. The MZI 203-3 is configured to combine the two CW laser light input wavelengths λ₁ and λ₅ onto the one optical output 203o-3.

The MZI 203-4 has two optical inputs 203i1-4 and 203i2-4 that receive CW laser light input wavelengths λ₃ and λ₇, respectively. The two optical inputs 203i1-4 and 203i2-4 correspond to input channels 7 and 8 of the M×1 cascaded MUX network 200, respectively. The MZI 203-4 has an optical output 203o-4. The MZI 203-4 is configured to combine the two CW laser light input wavelengths λ₃ and λ₇ onto the one optical output 203o-4.

The MZI 205-1 has two optical inputs 205i1-1 and 205i2-1 optically connected to the optical outputs 203o-1 and 203o-2, respectively, of the MZI 203-1 and the MZI 203-2, respectively. In this manner, the CW laser light input wavelengths λ₂ and λ₆ are conveyed to the optical input 205i1-1, and the CW laser light input wavelengths λ₄ and λ₈ are conveyed to the optical input 205i2-1. The MZI 205-1 has an optical output 205o-1. The MZI 205-1 is configured to combine the four CW laser light input wavelengths λ₂, λ₄, λ₆, and λ₈ onto the one optical output 205o-1.

The MZI 205-2 has two optical inputs 205i1-2 and 205i2-2 optically connected to the optical outputs 203o-3 and 203o-4, respectively, of the MZI 203-3 and the MZI 203-4, respectively. In this manner, the CW laser light input wavelengths λ₁ and λ₅ are conveyed to the optical input 205i1-2, and the CW laser light input wavelengths λ₃ and λ₇ are conveyed to the optical input 205i2-2. The MZI 205-2 has an optical output 205o-2. The MZI 205-2 is configured to combine the four CW laser light input wavelengths λ₁, λ₃, λ₅, and λ₇ onto the one optical output 205o-2.

The MZI 207 has two optical inputs 207i1 and 207i2 optically connected to the optical outputs 205o-1 and 205o-2, respectively, of the MZI 205-1 and the MZI 205-2, respectively. In this manner, the CW laser light input wavelengths λ₂, λ₄, λ₆, and λ₈ are conveyed to the optical input 207i1, and the CW laser light input wavelengths λ₁, λ₃, λ₅, and λ₇ are conveyed to the optical input 207i2. The MZI 207 has an optical output 207o. The MZI 207 is configured to combine the eight CW laser light input wavelengths λ₁, λ₂, λ₃, λ₄, λ₅, λ₆, λ₇, and λ₈ onto the one optical output 207o.

The architecture of the M×1 cascaded MUX network 200 can be expanded by adding MZI stages at the front-end side (at the channel input side, i.e., left side), such that the number (M) of channel inputs equal 2ⁿ (i.e., M=2ⁿ) for arbitrary (n), where (n) is the integer number of MZI stages. In the 8×1 wavelength combiner example of FIG. 2A, the integer number of MZI stages (n) equals 3, such that (M) equals 8.

The optical path length difference in the MZI's in each consecutive MZI stage 201-1, 201-2, and 201-3 is approximately doubled to decrease the FSR by approximately two in each consecutive MZI stage. For example, the optical path length in a given one of the MZI's 205-1 and 205-2 in the second MZI stage 201-2 is approximately two times the optical path length in a given one of the MZI's 203-1, 203-2, 203-4, and 203-5 in the first MZI stage 201-1, such that the FSR in the second MZI stage 201-2 is approximately one-half of the FSR in the first MZI stage 201-1. Similarly, the optical path length in the MZI 207 in the third MZI stage 201-3 is approximately two times the optical path length in a given one of the MZI's 205-1 and 205-2 in the second MZI stage 201-2, such that the FSR in the third MZI stage 201-3 is approximately one-half of the FSR in the second MZI stage 201-2. The increase in the optical path length in the MZI's of successive MZI stages is shown in the MZI's 203-1, 203-2, 203-3, 203-4, 205-1, 205-2, and 207 FIG. 2A, although not to scale.

FIG. 2B shows the relative intensities of the CW laser light of the different light wavelengths λ₁, λ₂, λ₃, λ₄, λ₅, λ₆, λ₇, and λ₈ as output from the 8×1 cascaded MUX network 200, in accordance with some embodiments. With reference to FIG. 2A, it should be noted that the CW laser light wavelengths λ₁, λ₂, λ₃, λ₄, λ₅, λ₆, λ₇, and λ₈ are not in the order of the input channel locations. The CW laser light wavelength input sequence is adjusted to λ₆, λ₂, λ₄, λ₈, λ₁, λ₅, λ₃, λ₇ for input channels 1 to 8, respectively, in order to match the input acceptance wavelengths of the MZI's (MUX's) 203-1, 203-2, 203-3, and 203-4 in the first MZI stage 201-1.

In some embodiments, the M×1 (M=8) cascaded MUX network 200 is implemented as a multiplexer/demultiplexer (MUX/DEMUX) in a WDM system. In some embodiments, the output 207o of the M×1 cascaded MUX network 200 is optically connected to a 1×N optical splitter to create an M×N optical distribution network, where M is 8. In some embodiments, an M×1 cascaded MUX network of arbitrary M, where M=2ⁿ with (n) being an integer, similar to the M×1 cascaded MUX network 200, has an optical output optically connected to an optical input of a 1×N optical splitter to create an M×N optical distribution network.

FIG. 2C shows the M×1 cascaded MUX network 200, where M=8, optically connected to the laser array 101, in accordance with some embodiments. The Lasers 1 to 8 are tuned to output CW laser light wavelengths λ₆, λ₂, λ₄, λ₈, λ₁, λ₅, λ₃, λ₇, respectively, for input channels 1 to 8, respectively. In this manner, the CW laser light input wavelengths are set to match the MUX acceptance wavelengths of the MZI inputs 203i1-1, 203i2-1, 203i1-2, 203i2-2, 203i1-3, 203i2-3, 203i1-4, and 203i2-4, respectively, of MZI stage 201-1. The laser array 101 is configured with a CW laser light wavelength sequence that matches the input wavelength sequence of the first MUX stage (MZI stage 201-1) of the MUX network of the M×1 cascaded MUX network 200 to which the laser array 101 is optically connected. The CW laser light wavelength sequence of the laser array 101 is a non-monotonic wavelength sequence. Regardless of the number (M) of outputs of the laser array 101, the CW laser light wavelength sequence of the laser array 101 is configured to match the acceptance wavelength sequence of the first MUX stage (MZI stage 201-1) of the M×1 cascaded MUX network 200 to which the laser array 101 is optically connected. In this manner, the number (M) of outputs of the laser array 101 and the number of channel inputs of the M×1 cascaded MUX network 200 is scalable.

FIG. 2D shows input port light wavelength acceptance passbands of the MZI's (MUX's) 203-1, 203-2, 203-3, 203-4 in the first MZI stage 201-1, the MZI's (MUX's) 205-1, 205-2 in the second MZI stage 201-2, and the MZI (MUX) 207 in the third MZI stage 201-3, in accordance with some embodiments. FIG. 2D shows that the optical bandwidth of the acceptance passbands decreases with each subsequent MZI stage 201-2 and 201-3 moving in the direction away from the laser array 101 CW light source toward the third MZI stage 201-3. In the final (third) MZI stage 201-3, the width of each of the wavelength acceptance passbands is limited by the channel-to-channel wavelength separation requirements. During the manufacturing process of the M×1 (M=8) cascaded MUX network 200, there could be variations or deviations from target values in the physical properties of the optical components in the M×1 (M=8) cascaded MUX network 200. For instance, process variations could result in variability or deviations in the optical refractive index of the waveguiding material and/or the dimensions of patterned structures, which in turn can result in a wavelength shift in the wavelength acceptance passbands of the MZI's (MUX's) 203-1, 203-2, 203-3, 203-4, 205-1, 205-2, and 207. Also, because the MZI's (MUX's) 203-1, 203-2, 203-3, 203-4, 205-1, 205-2, and 207 are formed of material(s) that have a non-zero thermo-optic coefficient, a change in temperature of the M×1 cascaded MUX network 200 will result in a shift in the wavelength acceptance passbands of the MZI's (MUX's) 203-1, 203-2, 203-3, 203-4, 205-1, 205-2, and 207. When the wavelength acceptance passbands of the MZI's (MUX's) 203-1, 203-2, 203-3, 203-4, 205-1, 205-2, and 207 shift with respect to the input wavelengths (λ₁, λ₂, λ₃, λ₄, λ₅, λ₆, λ₇, and λ₈), a narrower wavelength acceptance passband will result in a larger modulation of the optical output power than a wider wavelength acceptance passband. For this reason, the earlier (fore-positioned) MZI (MUX) stages (the MZI (MUX) stages closer to the laser array 101) in the M×1 cascaded MUX network 200 are less sensitive to fabrication process variations and are less temperature sensitive. Also, since there is a narrowing of the wavelength acceptance passbands with each subsequent MZI (MUX) stage moving in the direction away from the laser array 101 toward the last MZI (MUX) stage, removal of one or more MZI (MUX) stage(s) starting from the last MZI (MUX) stage and continuing in a direction toward the laser array 101 will reduce temperature sensitivity, where the last MZI (MUX) stage is the MZI (MUX) stage farthest away from the laser array 101. For example, the third MZI (MUX) stage 201-3 is the last MZI (MUX) stage in M×1 (M=8) cascaded MUX network 200.

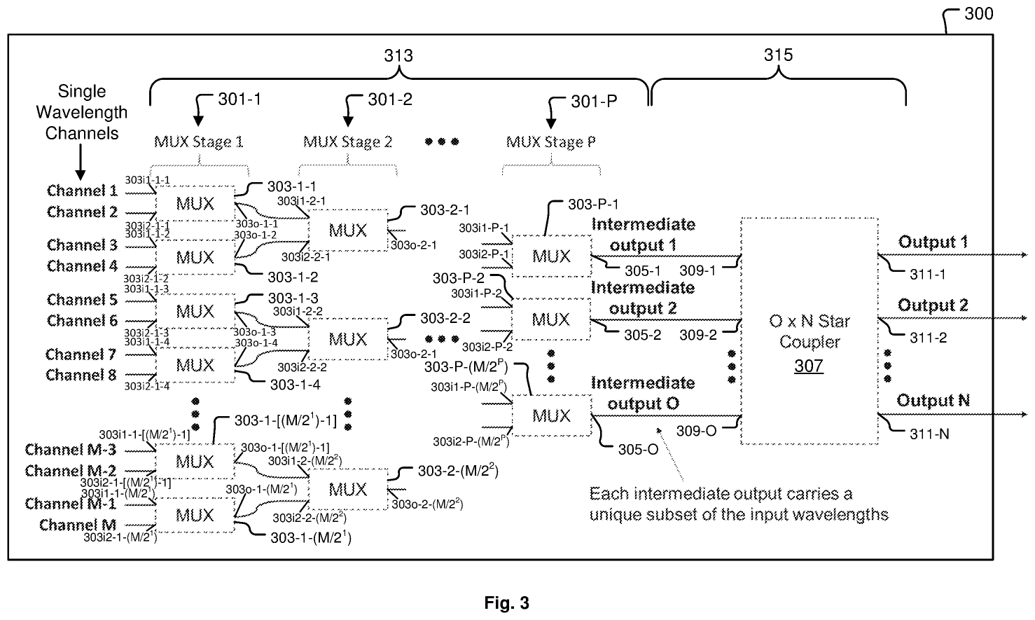

FIG. 3 shows an example architecture of an M×N optical distribution network 300 having M optical inputs and N optical outputs, where N is less than M, in accordance with some embodiments. The M×N optical distribution network 300 includes a fore-positioned (i.e., front-end or initial) optical MUX section 313 followed by an optical coupler section 315. The fore-positioned optical MUX section 313 includes a number P of MUX stages 301-1 to 301-P, where P is an integer greater than zero. A first MUX stage 301-1 is optically connected to a number M of optical input channels. In some embodiments, each of the M optical input channels is connected to convey CW laser light of one unique wavelength out of a set of M different light wavelengths (λ₁ to λ_{M}), such that each of the M optical input channels conveys a different light wavelength relative to the others of the M optical input channels. Each of the MUX stages 301-1 to 301-P includes a number K_{S} of 2-to-1 MUX's 303-S-Y, where S is the number of the MUX stage 301-S counting from the location of the M optical input channels into the fore-positioned MUX section 313, and Y is the identifier number of MUX in the MUX stage 301-S counting from 1 to K_{S}, where K_{S}=M/2^{S}, where M is the number optical input channels. For example, the first MUX stage 301-1 (for S=1) includes K₁=(M/2¹) 2-to-1 MUX's 303-1-Y, where Y goes from 1 to K₁. The second MUX stage 301-2 (for S=2) includes K₂=(M/2²) 2-to-1 MUX's 303-2-Y, where Y goes from 1 to K₂. The third MUX stage 301-3 (for S=3) includes K₃=(M/2³) 2-to-1 MUX's 303-3-Y, wherein Y goes from 1 to K₃, and so on. The P-th (last) MUX stage 301-P (for S=P) of the fore-positioned MUX section 313 includes K_{P}=(M/2^{P}) 2-to-1 MUX's 303-P-Y, where Y goes from 1 to K_{P}. Each of the MUX's 303-S-Y includes a first optical input 303i1-S-Y, a second optical input 303i2-S-Y, and an optical output 303o-S-Y.

Each of the MUX's 303-S-Y of the MUX stages 301-1 to 301-P is configured to receive a first set of one or more distinct wavelengths of CW laser light on a corresponding first optical input 303i1-S-Y and a second set of one or more distinct wavelengths of CW laser light on a corresponding second optical input 303i2-S-Y, where the first and second sets of one or more distinct wavelengths of CW laser light are mutually exclusive of each other. Also, each MUX 303-S-Y is configured to output a third set of multiple distinct wavelengths of CW laser light onto a corresponding common (single) optical output 303o-S-Y. The third set of multiple distinct wavelengths of CW laser light conveyed through the optical output 303o-S-Y includes each of the distinct wavelengths of CW laser light of the first and second sets of one or more distinct wavelengths of CW laser light that are received on the corresponding first optical input 303i1-S-Y and the corresponding second optical input 303i2-S-Y, respectively. The last MUX stage 301-P of the fore-positioned optical MUX section 313 includes a number O of MUX's 303-P-1 to 303-P-O, where O is an integer equal to (M/2^{P}), i.e., O=(M/2^{P}), where M is the number optical input channels, and P is the number of optical MUX stages in the fore-positioned optical MUX section 313. Therefore, the MUX's 303-P-1 to 303-P-O of the last MUX stage 301-P of the fore-positioned optical MUX section 313 collectively have the number O of optical outputs 305-1 to 305-O. The O optical outputs 305-1 to 305-O of the fore-positioned optical MUX section 313 are referred to as O intermediate optical output ports of the M×N optical distribution network 300.

The O optical outputs 305-1 to 305-O are optically connected to O optical inputs 309-1 to 309-O, respectively, of an O×N star coupler 307 within the optical coupler section 315 that follows the fore-positioned optical MUX section 313 within the M×N optical distribution network 300. Each of the O optical outputs 305-1 to 305-O conveys a unique set of multiple wavelengths of CW laser light to a corresponding one of the O optical inputs 309-1 to 309-O of the O×N star coupler 307, such that any given one of the O optical inputs 309-1 to 309-O receives a mutually exclusive set of CW laser light wavelengths relative to the others of the O optical inputs 309-1 to 309-O. The O×N star coupler 307 is configured to convey each of the CW laser light wavelengths received on each of the O optical inputs 309-1 to 309-O to each of a number N of optical outputs 311-1 to 311-N of the O×N star coupler 307. In this manner, each of the N optical outputs 311-1 to 311-N conveys all M of the wavelengths of CW laser light received across all of the O optical inputs 309-1 to 309-O, which corresponds to all M wavelengths of light (λ₁, to λ_{M}) received on optical input channels 1 to M.

As discussed above, in the M×N optical distribution network 300, M unique wavelength (λ₁, to λ_{M}) channels are routed into a network of P MUX stages 301-1 to 301-P, where P is greater than or equal to one. The sequence of the M light wavelengths conveyed through the M optical input channels does not necessarily match the optical input channel sequence. More specifically, the values of the M light wavelengths conveyed through the M optical input channels do not necessarily increase or decrease monotonically with the optical input channel number. After the P MUX stages 301-1 to 301-P, the M light wavelengths are combined into 0 intermediate optical output ports 305-1 to 305-O, where each of the O intermediate optical output ports 305-1 to 305-O conveys a unique and mutually exclusive subset of the M input wavelengths. The light conveyed through the O intermediate optical output ports 305-1 to 305-O is then distributed to the N optical outputs 311-1 to 311-N by the O×N star coupler 307, such that each of the N optical outputs 311-1 to 311-N conveys all M light wavelengths (λ₁, to λ_{M}) that were received across the M optical input channels. Therefore, the M×N optical distribution network 300 includes an M×O cascaded MUX network (the fore-positioned optical MUX section 313) having 0 intermediate optical outputs 305-1 to 305-O, where O is greater than one and where each of the O intermediate optical outputs 305-1 to 305-O conveys a unique subset of the M input light wavelengths. Also, within the M×N optical distribution network 300, the M×O cascaded MUX network (the fore-positioned optical MUX section 313) is followed by the O×N star coupler 307 (the optical coupler section 315), where N is greater than or equal to 0.

As compared to the M×1 cascaded MUX network (such as the M×1 cascaded MUX network 200 shown in FIG. 2A), it should be understood that the M×N optical distribution network 300 of FIG. 3 implements a reduced number of MUX stages 301-1 to 301-P, because the number O of intermediate optical outputs 305-1 to 305-O is greater than 1, and because the O×N star coupler 307 is implemented to combine the light received through the O intermediate optical outputs 305-1 to 305-O and distribute that combined light onto each of the N optical outputs 311-1 to 311-N. The reduced number of MUX stages 301-1 to 301-P makes it easier to meet fabrication tolerances within a given chip footprint and correspondingly provides for more reliable optical transmission through the overall M×N optical distribution network 300. Also, in comparison with the M×1 cascaded MUX network (such as the M×1 cascaded MUX network 200 shown in FIG. 2A), it should be understood that the M×N optical distribution network 300 of FIG. 3, with the number O of intermediate optical outputs 305-1 to 305-O greater than 1, is less sensitive to fabrication process variations and less sensitive to thermal shifts. This reduced sensitivity to fabrication process variations and thermal shifts in the M×N optical distribution network 300 is provided by removal of one or more of the end-positioned MUX stage(s) 301-(P+) that would necessary be present in the M×1 cascaded MUX network, where P+ represents a collective count of the one or more end-positioned MUX stage(s) 301-(P+) that are replaced by the O×N star coupler 307 in order to achieve the M×N optical distribution network 300. Therefore, in comparison with the M×1 cascaded MUX network (such as the M×1 cascaded MUX network 200 shown in FIG. 2A), the optical transmission performance of the M×N optical distribution network 300 of FIG. 3 is less sensitive to variations in temperature of the M×N optical distribution network 300.

In the optical distribution network 300, each of the plurality of optical inputs (303i1-1-m and 303i2-1-m, where m is 1 to (M/2)) of the fore-positioned optical multiplexer section 313 is configured to receive a respective one of a plurality of input light signals of different wavelengths (λ₁ to λ_{M}). The fore-positioned optical multiplexer section 313 is configured to multiplex a unique subset of the plurality of input light signals onto each of the plurality of intermediate optical outputs (305-1 to 305-O). The unique subset of the plurality of input light signals multiplexed on any given one of the plurality of intermediate optical outputs (305-1 to 305-O) is mutually exclusive with respect to the plurality of input light signals multiplexed on others of the plurality of intermediate optical outputs (305-1 to 305-O). The optical coupler section 315 is configured to distribute a portion of each light signal received at each of the plurality of optical inputs (309-1 to 309-O) of the optical coupler section 315 to each and every one of the plurality of optical outputs (311-1 to 311-N) of the optical coupler section 315. In some embodiments, the optical coupler section 315 is implemented as a free-space optical star coupler. In some embodiments, the optical coupler section 315 is implemented as a network of two-by-two optical couplers.

The fore-positioned optical multiplexer section 313 includes the number (P) of optical multiplexer stages (301-1 to 301-P). The number (P) is equal to a first value divided by a logarithm of two, where the first value is a logarithm of a second value, and where the second value is equal to the number (M) of the plurality of optical inputs (303i1-1-m and 303i2-1-m, where m is 1 to (M/2)) of the fore-positioned optical multiplexer section 313 divided by the number (O) of the plurality of intermediate optical outputs (305-1 to 305-O) of the fore-positioned optical multiplexer section 313. Each of the number (P) of optical multiplexer stages (301-1 to 301-P) includes a number (K_{S}) of two-to-one optical multiplexers 303-S-Y, where (S) is an integer sequence number of a given one of the number (P) of optical multiplexer stages (301-1 to 301-P) counting from a first one of the number (P) of optical multiplexer stages (301-1 to 301-P) to a last one of the number (P) of optical multiplexer stages (301-1 to 301-P), and where Y is a multiplexer number from 1 to (M/2^{P}) within the S-th one of the optical multiplexer stages (301-1 to 301-P). The first one of the number (P) of optical multiplexer stages (301-1 to 301-P) has optical inputs optically connected to the number (M) of the plurality of optical inputs (303i1-1-m and 303i2-1-m, where m is 1 to (M/2)) of the fore-positioned optical multiplexer section 313. The last one of the number (P) of optical multiplexer stages (301-1 to 301-P) has optical outputs optically connected to the number (0) of the plurality of intermediate optical outputs (305-1 to 305-O) of the fore-positioned optical multiplexer section 313. The number (K_{S}) is equal to the number (M) of the plurality of optical inputs (303i1-1-m and 303i2-1-m, where m is 1 to (M/2)) of the fore-positioned optical multiplexer section 313 divided by a value equal to 2^{S}.

Each of the number (K_{S}) of two-to-one optical multiplexers 303-S-Y includes a first optical input, a second optical input, and an optical output. Each of the number (K_{S}) of two-to-one optical multiplexers 303-S-Y is configured to combine light signals received on its first and second optical inputs onto its optical output. Each of a number (K₁) of two-to-one optical multiplexers in the first optical multiplexer stage of the number (P) of optical multiplexer stages is configured to have a first optical wavelength passband for its first optical input and a second optical wavelength passband for its second optical input, where the second optical wavelength passband is different than the first optical wavelength passband. In some embodiments, the first optical wavelength passband and the second optical wavelength passband correspond to non-sequential channel wavelengths of continuous wave laser light input to the optical distribution network.

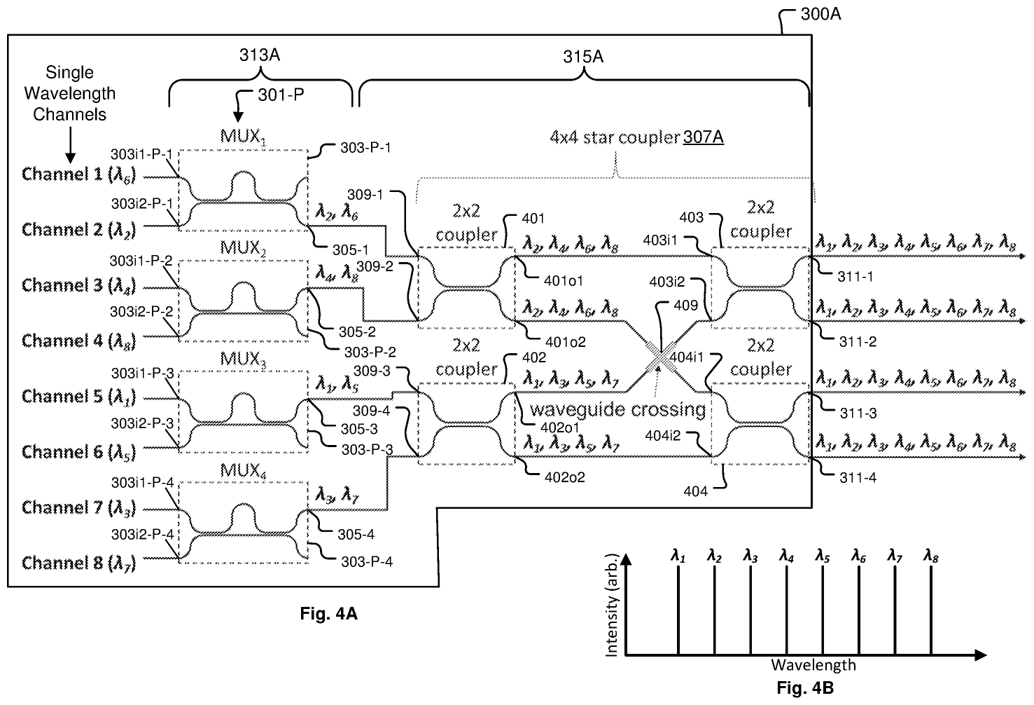

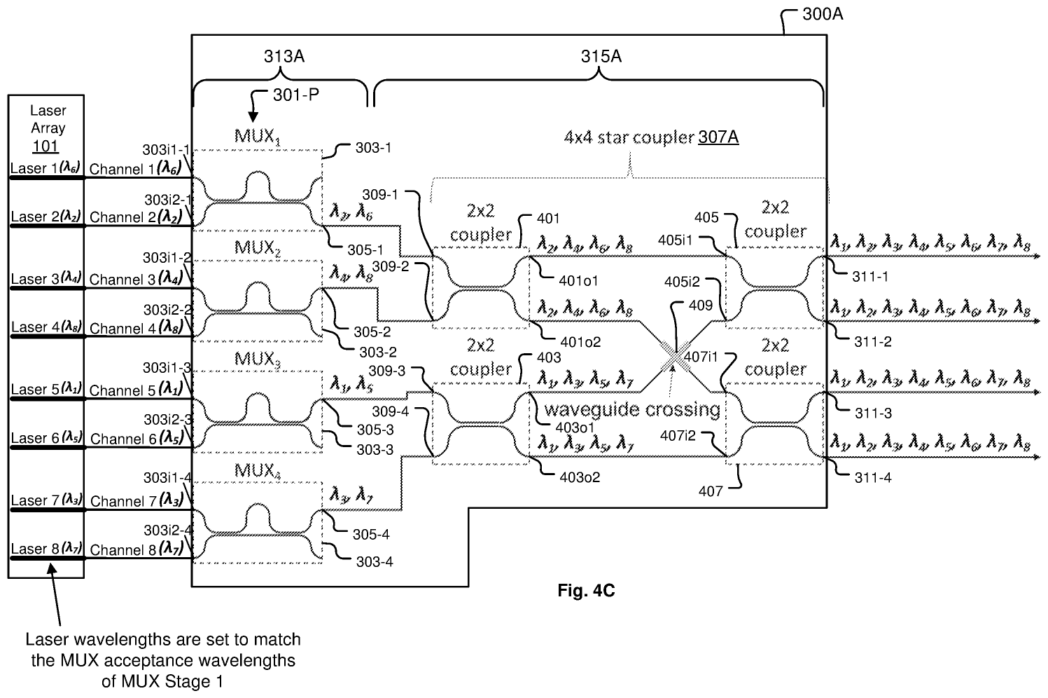

FIG. 4A shows an 8×4 optical distribution network 300A that is an example implementation of the M×N optical distribution network 300 of FIG. 3, in accordance with some embodiments. The 8×4 optical distribution network 300A includes a fore-positioned optical MUX section 313A that includes one MUX stage 301-P, where P=1. The 8×4 optical distribution network 300A also includes an optical coupler section 315A that includes a 4×4 star coupler 307A. In the 8×4 optical distribution network 300A, the number M of optical input channels is eight (Channel 1 to Channel 8), the number P of MUX stages is one (303-P, where P=1), the number O of intermediate optical outputs is four (305-1 to 305-4), and the number N of optical outputs is four (311-1 to 311-4). In this manner, the 8×4 optical distribution network 300A is configured to convey each and every one of the eight different CW laser light wavelengths received across the eight input channels to each of the four optical outputs 311-1, 311-2, 311-3, and 311-4 of the 8×4 optical distribution network 300A.

The MUX stage 301-P (which is the first and last MUX stage) in the 8×4 optical distribution network 300A includes four 2-to-1 MUX's 303-P-1, 303-P-2, 303-P-3, and 303-P-4. In some embodiments, each of the MUX's 303-P-1 to 303-P-4 is implemented as an MZI. Each of the four MUX's 303-P-1 to 303-P-4 has a respective first optical input 303i1-P-x, a respective second optical input 303i2-P-x, and a respective optical output 305-x, where x is the integer number of a given one of the MUX's 303-P-1 to 303-P-4. The ordering of the CW light wavelengths of the eight optical input channels (Channel 1 to Channel 8) is λ₆, λ₂, λ₄, λ₅, λ₁, λ₅, λ₃, λ₇, respectively, so as to match the MUX acceptance wavelengths of the MUX's 303-P-1 to 303-P-4. In this manner, the first MUX 303-P-1 combines the light wavelengths λ₂ and λ₆ onto the optical output 305-1. The second MUX 303-P-2 combines the light wavelengths λ₄ and λ₈ onto the optical output 305-2. The third MUX 303-P-3 combines the light wavelengths λ₁ and λ₅ onto the optical output 305-3. And, the fourth MUX 303-P-4 combines the light wavelengths λ₃ and λ₇ onto the optical output 305-4. Therefore, the two light wavelengths on each of the optical outputs 305-1 to 305-4 are separated from each other by four channel-to-channel light wavelength spacings.

The 4×4 star coupler 307A includes a first 2×2 optical coupler 401, a second 2×2 optical coupler 402, a third 2×2 optical coupler 403, and a fourth 2×2 optical coupler 404. The first 2×2 optical coupler 401 has a first optical input 309-1 optically connected to the optical output 305-1 of the first MUX 303-P-1, and a second optical input 309-2 optically connected to the optical output 305-2 of the second MUX 303-P-2. In this manner the first 2×2 optical coupler 401 receives the two CW laser light wavelengths λ₂ and λ₆ on the first optical input 309-1, and receives the two CW laser light wavelengths λ₄ and λ₈ on the second optical input 309-2. The first 2×2 optical coupler 401 has a first optical output 401o1 and a second optical output 401o2. The first 2×2 optical coupler 401 is configured to combine all of the light wavelengths received on the first optical input 309-1 and the second optical input 309-2 onto each of the two optical outputs 401o1 and 401o2. In this manner, each of the four CW laser light wavelengths λ₂, λ₄, λ₆, and λ₈ is output through each of the first optical output 401o1 and the second optical output 401o2.

The second 2×2 optical coupler 402 has a first optical input 309-3 optically connected to the optical output 305-3 of the third MUX 303-P-3, and a second optical input 309-4 optically connected to the optical output 305-4 of the fourth MUX 303-P-4. In this manner the second 2×2 optical coupler 402 receives the two CW laser light wavelengths λ₁ and λ₅ on the first optical input 309-3, and receives the two CW laser light wavelengths λ₃ and λ₇ on the second optical input 309-4. The second 2×2 optical coupler 402 has a first optical output 402o1 and a second optical output 402o2. The second 2×2 optical coupler 402 is configured to combine all of the CW laser light wavelengths received on the first optical input 309-3 and the second optical input 309-4 onto each of the two optical outputs 402o1 and 402o2. In this manner, each of the four CW laser light wavelengths λ₁, λ₃, λ₅, and λ₇ is output through each of the first optical output 402o1 and the second optical output 402o2.

The third 2×2 optical coupler 403 has a first optical input 403i1 optically connected to the first optical output 401o1 of the first 2×2 optical coupler 401, and a second optical input 403i2 optically connected to the first optical output 402o1 of the second 2×2 optical coupler 402. In this manner the third 2×2 optical coupler 403 receives the four CW laser light wavelengths λ₂, λ₄, λ₆, and λ₈ on the first optical input 403i1, and receives the four CW laser light wavelengths λ₁, λ₃, λ₅, and λ₇ on the second optical input 403i2. The third 2×2 optical coupler 403 has a first optical output 311-1 and a second optical output 311-2. The third 2×2 optical coupler 403 is configured to combine all of the CW laser light wavelengths received on the first optical input 403i1 and the second optical input 403i2 onto each of the two optical outputs 311-1 and 311-2. In this manner, each of the eight CW laser light wavelengths λ₁, λ₂, λ₃, λ₄, λ₅, λ₆, λ₇, and λ₈ is output through each of the first optical output 311-1 and the second optical output 311-2 of the third 2×2 optical coupler 403.

The fourth 2×2 optical coupler 404 has a first optical input 404i1 optically connected to the second optical output 401o2 of the first 2×2 optical coupler 401, and a second optical input 404i2 optically connected to the second optical output 402o2 of the second 2×2 optical coupler 402. In this manner the fourth 2×2 optical coupler 404 receives the four CW laser light wavelengths λ₂, λ₄, λ₆, and λ₈ on the first optical input 404i1, and receives the four CW laser light wavelengths λ₁, λ₃, λ₅, and λ₇ on the second optical input 404i2. The fourth 2×2 optical coupler 404 has a first optical output 311-3 and a second optical output 311-4. The fourth 2×2 optical coupler 404 is configured to combine all of the CW laser light wavelengths received on the first optical input 404i1 and the second optical input 404i2 onto each of the two optical outputs 311-3 and 311-4. In this manner, each of the eight CW laser light wavelengths λ₁, λ₂, λ₃, λ₄, λ₅, λ₆, λ₇, and λ₈ is output through each of the first optical output 311-3 and the second optical output 311-4 of the fourth 2×2 optical coupler 404.

An optical waveguide crossing 409 is implemented within the 4×4 star coupler 307A to provide for optical connection between the second optical output 401o2 of the first 2×2 optical coupler 401 and the first optical input 404i1 of the fourth 2×2 optical coupler 404, while also providing for optical connection between the first optical output 402o1 of the second 2×2 optical coupler 402 and the second optical input 403i2 of the third 2×2 optical coupler 403. The optical waveguide crossing 409 is configured to ensure that light traveling from the second optical output 401o2 of the first 2×2 optical coupler 401 to the first optical input 404i1 of the fourth 2×2 optical coupler 404 does not interfere with by light traveling from the first optical output 402o1 of the second 2×2 optical coupler 402 to the second optical input 403i2 of the third 2×2 optical coupler 403, and vice-versa.

FIG. 4B shows the relative intensities of the CW laser light of the different light wavelengths λ₁, λ₂, λ₃, λ₄, λ₅, λ₆, λ₇, and λ₈ as output from the 8×4 optical distribution network 300A of FIG. 4A, in accordance with some embodiments. With reference to FIG. 4A, it should be noted that the input light wavelengths λ₁, λ₂, λ₃, λ₄, λ₅, λ₆, λ₇, and λ₈ are not in the order of the input channel locations. The input light wavelength sequence is adjusted to λ₆, λ₂, λ₄, λ₅, λ₁, λ₅, λ₃, λ₇ for input channels 1 to 8, respectively, in order to match the input acceptance wavelengths of the MUX's 303-P-1 to 303-P-4 in the first (and last) MUX stage 301-P.

FIG. 4C shows the 8×4 optical distribution network 300A of FIG. 4A optically connected to the laser array 101, in accordance with some embodiments. The Lasers 1 to 8 are tuned to output CW laser light wavelengths λ₆, λ₂, λ₄, Δ₈, λ₁, λ₅, λ₃, λ₇ for input channels 1 to 8, respectively. In this manner, the sequence of the CW laser light wavelengths across the laser array 101 from Laser 1 to Laser 8 is set to substantially match the peaks of the input light wavelength acceptance passbands of the optical inputs 303i1-1, 303i2-1, 303i1-2, 303i2-2, 303i1-3, 303i2-3, 303i1-4, and 303i2-4, respectively, of the MUX's 303-1 to 303-4 in the first MUX stage 301-P (P=1) of the fore-positioned optical MUX section 313A of the 8×4 optical distribution network 300A.

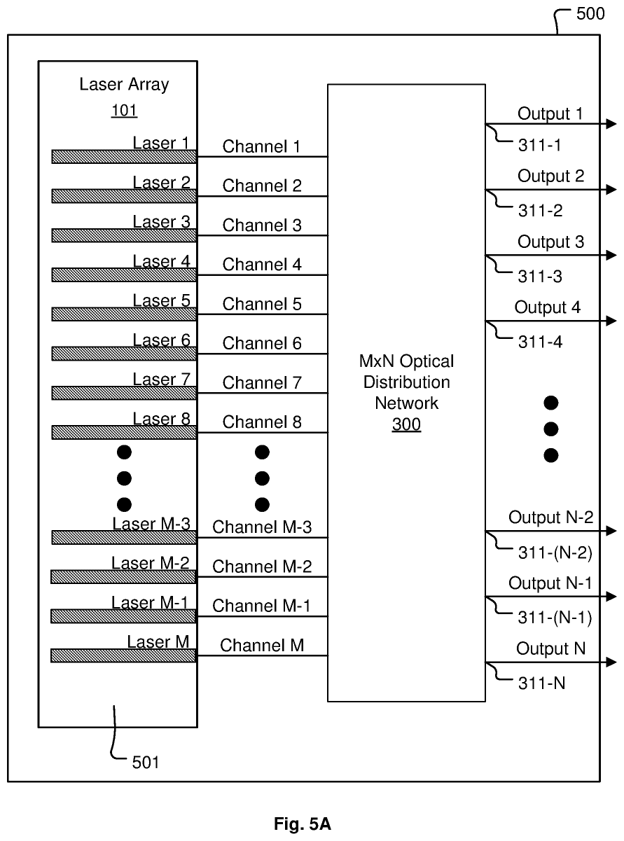

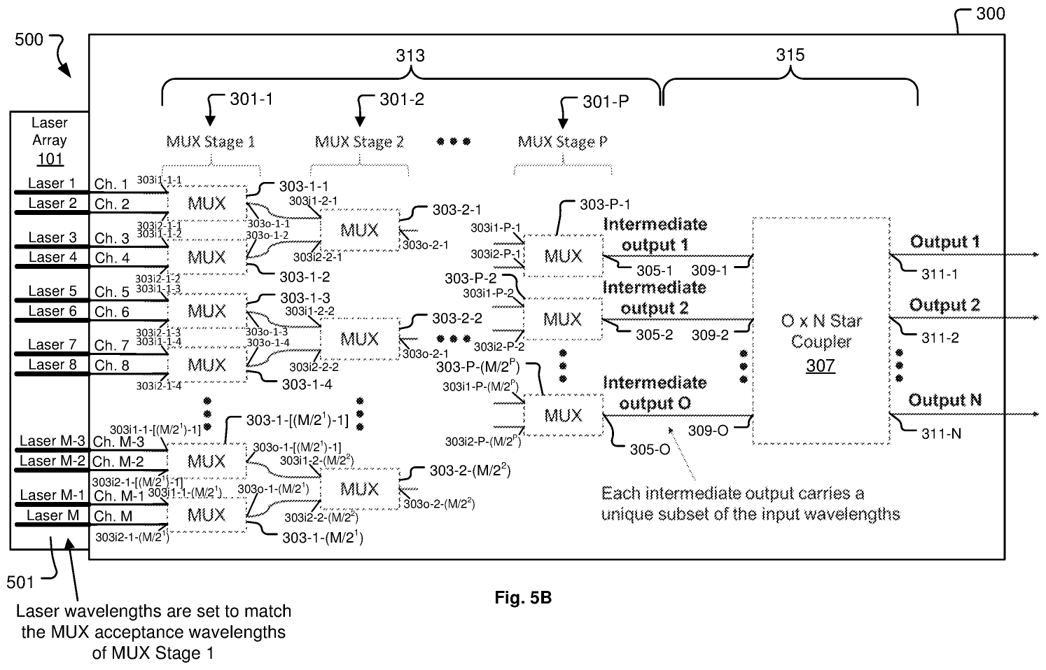

FIG. 5A shows a system in which the laser array 101 is directly coupled to the M×N optical distribution network 300 of FIG. 3 to form a laser module 500, in accordance with some embodiments. FIG. 5B shows the diagram of FIG. 5A with the M×N optical distribution network 300 depicted in detail, in accordance with some embodiments. In some embodiments, in the system of FIGS. 5A and 5B, the laser module 500, including the M×N optical distribution network 300, is integrated on a (i.e., one) semiconductor electro-optical chip (“chip”). In this sense, the M×N optical distribution network 300 is a chip-scale M×N optical distribution network 300.

The laser array 101 includes the number M of lasers, where each of the lasers 1 to M is tuned to output a unique wavelength of CW light into a respective one of M optical input channels (Channel 1 to Channel M) of the M×N optical distribution network 300. In this manner, the set of M lasers is tuned to collectively output M different wavelengths (λ₁ to λ_{M}) of CW laser light, with each laser outputting a different one of the M different wavelengths (λ₁ to λ_{M}) of CW laser light. In some embodiments, each of the M lasers in the laser array 101 is a distributed feedback (DFB) laser.

In some embodiments, at least one of the M lasers in the laser array 101 is thermally coupled to at least one other of the M lasers in the laser array, such that a change in temperature of one of the thermally coupled lasers results in a change in temperature of the at least one other of the thermally coupled lasers. In some embodiments, the M lasers in the laser array 101 are thermally coupled together in a collective manner, such that the respective temperatures of the M lasers change/drift together. In some embodiments, each of the M lasers in the laser array 101 is thermally connected to a common thermally conductive substrate/plate 501, such that the temperature of each of the M lasers in the laser array 101 is normalized to an average temperature based on the collective thermal output of the M lasers in the laser array 101, and such that temperatures of the M lasers in the laser array 101 drift together in direction and magnitude. In this manner, a temperature-induced wavelength variation will be substantially the same across the M lasers in the laser array 101, which serves to maintain relative wavelength spacings from laser-to-laser as the temperature-induced wavelength variation occurs. In some embodiments, the plurality of lasers (Laser 1 to Laser M) are arranged in the laser array 101 such that a sequence of the plurality of wavelengths of continuous wave laser light (as output by the Lasers 1 to M) is non-monotonically ordered across the laser array 101.

In some embodiments, the M×N optical distribution network 300 is a photonic integrated circuit (PIC) integrated on a semiconductor electro-optical chip with M optical input channels (Channel 1 to Channel M) and N optical output channels (Output 1 to Output N). The M optical input channels (Channel 1 to Channel M) respectively correspond to the optical inputs 303i1-1, 303i2-1-1 to 303i1-1-(M/2), 303i2-1-(M/2) of the MUX's 303-1-1 to 303-1-(M/2) in the first MUX stage 301-1 of the fore-positioned optical MUX section 313 of the M×N optical distribution network 300. The N optical output channels (Output 1 to Output N) respectively correspond to the N optical outputs 311-1 to 311-N of the optical coupler section 315 of the M×N optical distribution network 300. The M×N optical distribution network 300 is configured to distribute light from each of the M optical input channels (Channel 1 to Channel M) to all of the N optical output channels (Output 1 to Output N), such that each and every one of the N optical output channels (Output 1 to Output N) conveys CW laser light of all M different wavelengths (λ₁ to λ_{M}) as output by the laser array 101. The plurality of optical outputs (311-1 to 311-N) of the optical coupler section 315 respectively correspond to each of a plurality of optical outputs of the optical distribution network 300 and a plurality of outputs of the laser module 500.

In some embodiments, the laser array 101 is directly optically coupled to the M×N optical distribution network 300 without any intermediate light guiding components, such as optical fibers or optical waveguides, such that CW laser light from each of the M lasers in the laser array 101 is transmitted directly into the corresponding one of the M optical input channels (Channel 1 to Channel M) in the M×N optical distribution network 300 chip. For example, Laser 1 transmits CW laser light directly into optical input Channel 1, Laser 2 transmits CW laser light directly into optical input Channel 2, and so on, with Laser M transmitting CW laser light directly into optical input Channel M. In these embodiments, each of the M lasers in the laser array 101 is optically coupled directly to the corresponding physical optical channel in the M×N optical distribution network 300. It should be understood, however, that in various embodiments, essentially any method or technique of coupling light may be used to optically couple each of the M lasers in the laser array 101 to the corresponding one of the M optical input channels (Channel 1 to Channel M) in the M×N optical distribution network 300. For example, in some embodiments, optical coupling of the M lasers in the laser array 101 to the corresponding M optical input channels (Channel 1 to Channel M) in the M×N optical distribution network 300 is done by optical vertical grating coupling, optical edge coupling, and/or lens-based optical coupling, among other techniques, by way of example.

In some embodiments, the MUX's 303-1-1 to 303-1-(M/2) in the first MUX stage 301-1 of the fore-positioned optical MUX section 313 of the M×N optical distribution network 300 may require an input light wavelength sequence that is not linearly or monotonically varying (increasing/decreasing) with the physical optical input channel number. In these embodiments, the wavelengths of the CW laser light output by the M lasers in the laser array 101 are set to substantially match the peaks of the wavelength acceptance passbands of the MUX's 303-1-1 to 303-1-(M/2) in the first MUX stage 301-1 of the fore-positioned optical MUX section 313 of the M×N optical distribution network 300. Specifically, the Laser 1 in the laser array 101 is set to output CW laser light at a wavelength that substantially matches the peak of the wavelength acceptance passband of the first optical input 303i1-1-1 of the first MUX 303-1-1 of the first MUX stage 301-1, with the Laser 1 being directly optically coupled to the first optical input 303i1-1-1 of the first MUX 303-1-1 of the first MUX stage 301-1. Continuing on, the Laser 2 in the laser array 101 is set to output CW laser light at a wavelength that substantially matches the peak of the wavelength acceptance passband of the second optical input 303i2-1-1 of the first MUX 303-1-1 of the first MUX stage 301-1, with the Laser 2 being directly optically coupled to the second optical input 303i2-1-1 of the first MUX 303-1-1 of the first MUX stage 301-1. Continuing on, the Laser 3 in the laser array 101 is set to output CW laser light at a wavelength that substantially matches the peak of the wavelength acceptance passband of the first optical input 303i1-1-2 of the second MUX 303-1-2 of the first MUX stage 301-1, with the Laser 3 being directly optically coupled to the first optical input 303i1-1-2 of the second MUX 303-1-2 of the first MUX stage 301-1. Continuing on, the Laser 4 in the laser array 101 is set to output CW laser light at a wavelength that substantially matches the peak of the wavelength acceptance passband of the second optical input 303i2-1-2 of the second MUX 303-1-2 of the first MUX stage 301-1, with the Laser 4 being directly optically coupled to the second optical input 303i2-1-2 of the second MUX 303-1-2 of the first MUX stage 301-1, and so on. Then, finally, the Laser M in the laser array 101 is set to output CW laser light at a wavelength that substantially matches the peak of the wavelength acceptance passband of the second optical input 303i2-1-(M/2) of the last, i.e., (M/2), MUX 303-1-(M/2) of the first MUX stage 301-1, with the Laser M being directly optically coupled to the second optical input 303i2-1-(M/2) of the last MUX 303-1-(M/2) of the first MUX stage 301-1. In some embodiments, the laser array 101 is optically interfaced with the optical distribution network 300 such that the plurality of wavelengths of continuous wave laser light are transmitted directly from the plurality of lasers (Laser 1 to Laser M) into the plurality of optical inputs (303i1-1, 303i2-1-1 to 303i1-1-(M/2), 303i2-1-(M/2)) of the fore-positioned optical multiplexer section 313.

It should be understood that because the wavelengths of the CW laser light output by the M lasers in the laser array 101 are set to substantially match the peaks of the wavelength acceptance passbands of the MUX's 303-1-1 to 303-1-(M/2) in the first MUX stage 301-1 of the fore-positioned optical MUX section 313 of the M×N optical distribution network 300, the wavelengths of the CW laser light output by the M lasers in the laser array 101 may not vary in a monotonic manner from Laser 1 to Laser M in the laser array 101. Therefore, it should be appreciated that the laser array 101 is configured differently from conventional laser arrays that have only monotonically increasing or monotonically decreasing laser light output wavelengths along a sequence or series of lasers.

In order to optically connect a laser array that has only monotonically increasing or monotonically decreasing laser light output wavelengths along its sequence/series of lasers to the M×N optical distribution network 300 that has a non-monotonic input wavelength sequence, it would be necessary to route optical paths across each other between the laser array 101 and the M×N optical distribution network 300, such as by routing light through optical fibers connected between the laser array 101 and the M×N optical distribution network 300. In some embodiments, the non-monotonic ordering of the sequence of the plurality of wavelengths of CW laser light across the laser array 101 matches an ordering of wavelength acceptance passbands of the plurality of optical inputs (303i1-1, 303i2-1-1 to 303i1-1-(M/2), 303i2-1-(M/2)) of the fore-positioned optical multiplexer section 313. By setting each of the M lasers in the laser array 101 to output CW light having a particular wavelength that substantially matches the peak of the wavelength acceptance passband of the corresponding one of the M optical inputs of the M×N optical distribution network 300, it is possible to avoid having to route optical paths across one another in optically connecting the laser array 101 to the M×N optical distribution network 300. This is beneficial since routing optical paths across one another could result in additional optical insertion loss, which could occur, for example, if the optical routing had to be done in a single waveguiding layer in an integrated optical chip and correspondingly require the use of optical waveguide crossings, which typically have non-zero optical insertion loss.

In some embodiments, the M×N optical distribution network 300 is implemented to include the fore-positioned optical MUX section 313 including at least one MUX stage 301-x, where x is an integer from 1 to P, and where P is greater than or equal to one. However, in other embodiments, a variation of the M×N optical distribution network 300 is implemented without the fore-positioned optical MUX section 313, such that P is equal to zero. In these embodiments where P is equal to zero, the number O of intermediate optical output ports 305-1 to 305-O of the M×N optical distribution network 300 effectively becomes the number M of optical input channels (Channel 1 to Channel M) of the M×N optical distribution network 300. In these embodiments, with the fore-positioned optical MUX section 313 removed from the M×N optical distribution network 300, the number M of optical input channels (Channel 1 to Channel M) are respectively optically connected to the number O of optical inputs 309-1 to 309-O of the optical coupler section 315 of the M×N optical distribution network 300, i.e., such that the number M of optical input channels (Channel 1 to Channel M) are respectively optically connected to the number O of optical inputs of the O×N star coupler 307.

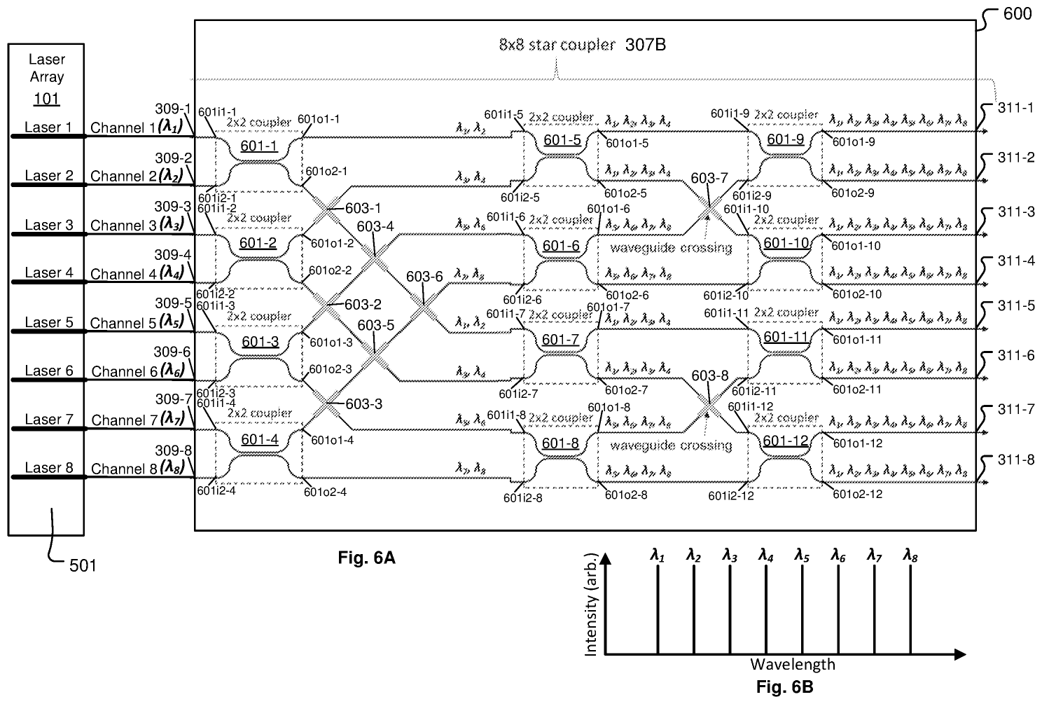

FIG. 6A shows a system in which the laser array 101 is directly coupled to an 8×8 optical distribution network 600, in accordance with some embodiments. FIG. 6B shows the relative intensities of the CW laser light of the different light wavelengths λ₁, λ₂, λ₃, λ₄, λ₅, λ₆, λ₇, and λ₈ as provided to the inputs 309-1 to 309-8 of the 8×8 optical distribution network 600 and as output through the outputs 311-1 to 311-8 of the 8×8 optical distribution network 600, in accordance with some embodiments. The 8×8 optical distribution network 600 is implemented as a variation of the M×N optical distribution network 300 of FIG. 3, where P equal zero, O equals M, M equals eight, and N equals eight. Therefore, because P is equal to zero, the 8×8 optical distribution network 600 does not include the fore-positioned optical MUX section 313. Because there is no fore-positioned optical MUX section 313, there is no initial MUX stage 301-1 that includes MUX's 303-1-1 to 301-1-(M/2) having varying optical input wavelength acceptance passbands. Therefore, in the 8×8 optical distribution network 600, the sequence of M lasers across the laser array 101 can be set to have essentially any ordering/sequence of CW laser light output wavelengths, including either a monotonically increasing order/sequence of CW laser light output wavelengths across the layer array 101, or an arbitrary, e.g., non-monotonically varying, order/sequence of CW laser light output wavelengths across the layer array 101. In some embodiments, the 8×8 optical distribution network 600 is integrated on a semiconductor electro-optical chip.

The laser array 101 of FIG. 6A includes eight lasers (Laser 1 to Laser 8), where each of the eight lasers is tuned to output a unique wavelength (λ₁ to λ₈) of CW laser light into a respective one of the eight optical input channels (Channel 1 to Channel 8) of the 8×8 optical distribution network 600. In some embodiments, each of the eight lasers in the laser array 101 is a distributed feedback (DFB) laser. Also, in some embodiments, the eight lasers in the laser array 101 are thermally coupled to each other, such that a change in temperature of one of the thermally coupled lasers results in a change in temperature of the others of the thermally coupled lasers. In these embodiments, the eight lasers in the laser array 101 are thermally coupled together in a collective manner, such that the respective temperatures of the eight lasers change/drift together. In some embodiments, each of the eight lasers in the laser array 101 is thermally connected/interfaced to the common thermally conductive substrate/plate 501, such that the temperature of each of the eight lasers in the laser array 101 is normalized to an average temperature based on the collective thermal output of the eight lasers in the laser array 101, and such that temperatures of the eight lasers in the laser array 101 drift together in direction and magnitude.

In some embodiments, the laser array 101 is directly coupled to the 8×8 optical distribution network 600 without any intermediate light guiding components, such as optical fibers or optical waveguides, such that CW laser light from each of the eight lasers (Laser 1 to Laser 8) in the laser array 101 radiates directly into the corresponding one of the eight optical input channels (Channel 1 to Channel M) in the 8×8 optical distribution network 600. It should be understood, however, that in various embodiments, essentially any method or technique of coupling light may be used to optically couple each of the eight lasers (Laser 1 to Laser 8) in the laser array 101 to the corresponding one of the eight optical input channels (Channel 1 to Channel M) in the 8×8 optical distribution network 600, such as vertical grating optical coupling, optical edge coupling, and/or lens-based optical coupling, among others, by way of example.

The 8×8 optical distribution network 600 is configured to distribute light from each and every one of the eight optical input channels (Channel 1 to Channel 8) to each one of the eight optical output channels 311-1 to 311-8, such that each and every one of the eight optical output channels 311-1 to 311-8 conveys CW laser light of all eight different wavelengths (λ₁ to λ₈) that are output by the laser array 101 and input to the 8×8 optical distribution network 600. The eight optical input channels (Channel 1 to Channel 8) respectively correspond to the optical inputs 309-1 to 309-O of the 8×8 optical distribution network 600, where O is eight. The eight optical output channels 311-1 to 311-8 respectively correspond to the optical outputs 311-1 to 311-N of the 8×8 optical distribution network 600, where N is eight.

In the 8×8 optical distribution network 600, the optical coupler section 315 is implemented as an 8×8 star coupler 307B that includes twelve 2×2 optical couplers 601-1 to 601-12. The first 2×2 optical coupler 601-1 has a first optical input 601i1-1 that is optically connected to the first optical input channel (Channel 1), and a second optical input 601i2-1 that is optically connected to the second optical input channel (Channel 2). In this manner the first 2×2 optical coupler 601-1 receives the CW laser light wavelength λ₁ on the first optical input 601i1-1, and receives the CW laser light wavelength λ₂ on the second optical input 601i2-1. The first 2×2 optical coupler 601-1 has a first optical output 601o1-1 and a second optical output 601o2-1. The first 2×2 optical coupler 601-1 is configured to combine the CW laser light wavelength λ₁ received on the first optical input 601i1-1 and the CW laser light wavelength λ₂ received on the second optical input 601i2-1 onto each of the two optical outputs 601o1-1 and 601o2-1. In this manner, each of the two CW laser light wavelengths λ₁ and λ₂ is output through each of the first optical output 601o1-1 and the second optical output 601o2-1.

The second 2×2 optical coupler 601-2 has a first optical input 601i1-2 that is optically connected to the third optical input channel (Channel 3), and a second optical input 601i2-2 that is optically connected to the fourth optical input channel (Channel 4). In this manner the second 2×2 optical coupler 601-2 receives the CW laser light wavelength λ₃ on the first optical input 601i1-2, and receives the CW laser light wavelength λ₄ on the second optical input 601i2-2. The second 2×2 optical coupler 601-2 has a first optical output 601o1-2 and a second optical output 601o2-2. The second 2×2 optical coupler 601-2 is configured to combine the CW laser light wavelength λ₃ received on the first optical input 601i1-2 and the CW laser light wavelength λ₄ received on the second optical input 601i2-2 onto each of the two optical outputs 601o1-2 and 601o2-2. In this manner, each of the two CW laser light wavelengths λ₃ and λ₄ is output through each of the first optical output 601o1-2 and the second optical output 601o2-2.

The third 2×2 optical coupler 601-3 has a first optical input 601i1-3 that is optically connected to the fifth optical input channel (Channel 5), and a second optical input 601i2-3 that is optically connected to the sixth optical input channel (Channel 6). In this manner the third 2×2 optical coupler 601-3 receives the CW laser light wavelength λ₅ on the first optical input 601i1-3, and receives the CW laser light wavelength λ₆ on the second optical input 601i2-3. The third 2×2 optical coupler 601-3 has a first optical output 601o1-3 and a second optical output 601o2-3. The third 2×2 optical coupler 601-3 is configured to combine the CW laser light wavelength λ₅ received on the first optical input 601i1-3 and the CW laser light wavelength λ₆ received on the second optical input 601i2-3 onto each of the two optical outputs 601o1-3 and 601o2-3. In this manner, each of the two CW laser light wavelengths λ₅ and λ₆ is output through each of the first optical output 601o1-3 and the second optical output 601o2-3.

The fourth 2×2 optical coupler 601-4 has a first optical input 601i1-4 that is optically connected to the seventh optical input channel (Channel 7), and a second optical input 601i2-4 that is optically connected to the eighth optical input channel (Channel 8). In this manner the fourth 2×2 optical coupler 601-4 receives the CW laser light wavelength λ₇ on the first optical input 601i1-4, and receives the CW laser light wavelength λ₈ on the second optical input 601i2-4. The fourth 2×2 optical coupler 601-4 has a first optical output 601o1-4 and a second optical output 601o2-4. The fourth 2×2 optical coupler 601-4 is configured to combine the CW laser light wavelength λ₇ received on the first optical input 601i1-4 and the CW laser light wavelength A₈ received on the second optical input 601i2-4 onto each of the two optical outputs 601o1-4 and 601o2-4. In this manner, each of the two CW laser light wavelengths λ₇ and λ₈ is output through each of the first optical output 601o1-4 and the second optical output 601o2-4.

The fifth 2×2 optical coupler 601-5 has a first optical input 601i1-5 optically connected to the first optical output 601o1-1 of the first 2×2 optical coupler 601-1, and a second optical input 601i2-5 optically connected to the first optical output 601o1-2 of the second 2×2 optical coupler 601-2. In this manner the fifth 2×2 optical coupler 601-5 receives the two CW laser light wavelengths λ₁ and λ₂ on the first optical input 601i1-5, and receives the two CW laser light wavelengths λ₃ and λ₄ on the second optical input 601i2-5. The fifth 2×2 optical coupler 601-5 has a first optical output 601o1-5 and a second optical output 601o2-5. The fifth 2×2 optical coupler 601-5 is configured to combine all of the CW laser light wavelengths received on the first optical input 601i1-5 and the second optical input 601i2-5 onto each of the two optical outputs 601o1-5 and 601o2-5. In this manner, each of the four CW laser light wavelengths λ₁, λ₂, λ₃, and λ₄ is output through each of the first optical output 601o1-5 and the second optical output 601o2-5 of the fifth 2×2 optical coupler 601-5.

The sixth 2×2 optical coupler 601-6 has a first optical input 601i1-6 optically connected to the first optical output 601o1-3 of the third 2×2 optical coupler 601-3, and a second optical input 601i2-6 optically connected to the first optical output 601o1-4 of the fourth 2×2 optical coupler 601-4. In this manner the sixth 2×2 optical coupler 601-6 receives the two CW laser light wavelengths λ₅ and λ₆ on the first optical input 601i1-6, and receives the two CW laser light wavelengths λ₇ and λ₈ on the second optical input 601i2-6. The sixth 2×2 optical coupler 601-6 has a first optical output 601o1-6 and a second optical output 601o2-6. The sixth 2×2 optical coupler 601-6 is configured to combine all of the CW laser light wavelengths received on the first optical input 601i1-6 and the second optical input 601i2-6 onto each of the two optical outputs 601o1-6 and 601o2-6. In this manner, each of the four CW laser light wavelengths A₅, λ₆, λ₇, and λ₈ is output through each of the first optical output 601o1-6 and the second optical output 601o2-6 of the sixth 2×2 optical coupler 601-6.

The seventh 2×2 optical coupler 601-7 has a first optical input 601i1-7 optically connected to the second optical output 601o2-1 of the first 2×2 optical coupler 601-1, and a second optical input 601i2-7 optically connected to the second optical output 601o2-2 of the second 2×2 optical coupler 601-2. In this manner the seventh 2×2 optical coupler 601-7 receives the two CW laser light wavelengths λ₁ and λ₂ on the first optical input 601i1-7, and receives the two CW laser light wavelengths λ₃ and λ₄ on the second optical input 601i2-7. The seventh 2×2 optical coupler 601-7 has a first optical output 601o1-7 and a second optical output 601o2-7. The seventh 2×2 optical coupler 601-7 is configured to combine all of the CW laser light wavelengths received on the first optical input 601i1-7 and the second optical input 601i2-7 onto each of the two optical outputs 601o1-7 and 601o2-7. In this manner, each of the four CW laser light wavelengths λ₁, λ₂, λ₃, and λ₄ is output through each of the first optical output 601o1-7 and the second optical output 601o2-7 of the seventh 2×2 optical coupler 601-7.

The eighth 2×2 optical coupler 601-8 has a first optical input 601i1-8 optically connected to the second optical output 601o2-3 of the third 2×2 optical coupler 601-3, and a second optical input 601i2-8 optically connected to the second optical output 601o2-4 of the fourth 2×2 optical coupler 601-4. In this manner the eighth 2×2 optical coupler 601-8 receives the two CW laser light wavelengths λ₅ and λ₆ on the first optical input 601i1-8, and receives the two CW laser light wavelengths λ₇ and λ₈ on the second optical input 601i2-8. The eighth 2×2 optical coupler 601-8 has a first optical output 601o1-8 and a second optical output 601o2-8. The eighth 2×2 optical coupler 601-8 is configured to combine all of the CW laser light wavelengths received on the first optical input 601i1-8 and the second optical input 601i2-8 onto each of the two optical outputs 601o1-8 and 601o2-8. In this manner, each of the four CW laser light wavelengths A₅, λ₆, λ₇, and λ₈ is output through each of the first optical output 601o1-8 and the second optical output 601o2-8 of the eighth 2×2 optical coupler 601-8.

The 8×8 star coupler 307B includes six optical waveguide crossings 603-1 to 603-6 to enable optical routings between optical outputs of the 2×2 optical couplers 601-1 to 601-4 and optical inputs of the 2×2 optical couplers 601-5 to 601-8 as described above. The optical waveguide crossing 603-1 enables optical routing between the first optical output 601o1-2 of the second 2×2 optical coupler 601-2 and the second optical input 601i2-5 of the fifth 2×2 optical coupler 601-5. The optical waveguide crossings 603-2 and 603-4 enable optical routing between the first optical output 601o1-3 of the third 2×2 optical coupler 601-3 and the first optical input 601i1-6 of the sixth 2×2 optical coupler 601-6. The optical waveguide crossings 603-3, 603-5, and 603-6 enable optical routing between the first optical output 601o1-4 of the fourth 2×2 optical coupler 601-4 and the second optical input 601i2-6 of the sixth 2×2 optical coupler 601-6. The optical waveguide crossings 603-1, 603-4, and 603-6 enable optical routing between the second optical output 601o2-1 of the first 2×2 optical coupler 601-1 and the first optical input 601i1-7 of the seventh 2×2 optical coupler 601-7. The optical waveguide crossings 603-2 and 603-5 enable optical routing between the second optical output 601o2-2 of the second 2×2 optical coupler 601-2 and the second optical input 601i2-7 of the seventh 2×2 optical coupler 601-7. The optical waveguide crossing 603-3 enables optical routing between the second optical output 601o2-3 of the third 2×2 optical coupler 601-3 and the first optical input 601i1-8 of the eighth 2×2 optical coupler 601-8. Each of the optical waveguide crossings 603-1 to 603-6 is configured to ensure that CW laser light traveling through each of two crossing optical waveguides does not interfere with each other.

The ninth 2×2 optical coupler 601-9 has a first optical input 601i1-9 optically connected to the first optical output 601o1-5 of the fifth 2×2 optical coupler 601-5, and a second optical input 601i2-9 optically connected to the first optical output 601o1-6 of the sixth 2×2 optical coupler 601-6. In this manner the ninth 2×2 optical coupler 601-9 receives the four CW laser light wavelengths λ₁, λ₂, λ₃, and λ₄ on the first optical input 601i1-9, and receives the four CW laser light wavelengths λ₅, λ₆, λ₇, and λ₈ on the second optical input 601i2-9. The ninth 2×2 optical coupler 601-9 has a first optical output 601o1-9 and a second optical output 601o2-9. The ninth 2×2 optical coupler 601-9 is configured to combine all of the light wavelengths received on the first optical input 601i1-9 and the second optical input 601i2-9 onto each of the two optical outputs 601o1-9 and 601o2-9. In this manner, each of the eight CW laser light wavelengths λ₁, λ₂, λ₃, λ₄, λ₅, λ₆, λ₇, and λ₈ is output through each of the first optical output 601o1-9 and the second optical output 601o2-9 of the ninth 2×2 optical coupler 601-9, which correspond to the optical outputs 311-1 and 311-2, respectively, of the 8×8 optical distribution network 600.

The tenth 2×2 optical coupler 601-10 has a first optical input 601i1-10 optically connected to the second optical output 601o2-5 of the fifth 2×2 optical coupler 601-5, and a second optical input 601i2-10 optically connected to the second optical output 601o2-6 of the sixth 2×2 optical coupler 601-6. In this manner the tenth 2×2 optical coupler 601-10 receives the four CW laser light wavelengths λ₁, λ₂, λ₃, and λ₄ on the first optical input 601i1-10, and receives the four CW laser light wavelengths λ₅, λ₆, λ₇, and λ₈ on the second optical input 601i2-10. The tenth 2×2 optical coupler 601-10 has a first optical output 601o1-10 and a second optical output 601o2-10. The tenth 2×2 optical coupler 601-10 is configured to combine all of the CW laser light wavelengths received on the first optical input 601i1-10 and the second optical input 601i2-10 onto each of the two optical outputs 601o1-10 and 601o2-10. In this manner, each of the eight CW laser light wavelengths λ₁, λ₂, λ₃, λ₄, λ₅, λ₆, λ₇, and λ₈ is output through each of the first optical output 601o1-10 and the second optical output 601o2-10 of the tenth 2×2 optical coupler 601-10, which correspond to the optical outputs 311-3 and 311-4, respectively, of the 8×8 optical distribution network 600.

The eleventh 2×2 optical coupler 601-11 has a first optical input 601i1-11 optically connected to the first optical output 601o1-7 of the seventh 2×2 optical coupler 601-7, and a second optical input 601i2-11 optically connected to the first optical output 601o1-8 of the eighth 2×2 optical coupler 601-8. In this manner the eleventh 2×2 optical coupler 601-11 receives the four CW laser light wavelengths λ₁, λ₂, λ₃, and λ₄ on the first optical input 601i1-11, and receives the four CW laser light wavelengths λ₅, λ₆, λ₇, and λ₈ on the second optical input 601i2-11. The eleventh 2×2 optical coupler 601-11 has a first optical output 601o1-11 and a second optical output 601o2-11. The eleventh 2×2 optical coupler 601-11 is configured to combine all of the CW laser light wavelengths received on the first optical input 601i1-11 and the second optical input 601i2-11 onto each of the two optical outputs 601o1-11 and 601o2-11. In this manner, each of the eight CW laser light wavelengths λ₁, λ₂, λ₃, λ₄, λ₅, λ₆, λ₇, and λ₈ is output through each of the first optical output 601o1-11 and the second optical output 601o2-11 of the eleventh 2×2 optical coupler 601-11, which correspond to the optical outputs 311-5 and 311-6, respectively, of the 8×8 optical distribution network 600.

The twelfth 2×2 optical coupler 601-12 has a first optical input 601i1-12 optically connected to the second optical output 601o2-7 of the seventh 2×2 optical coupler 601-7, and a second optical input 601i2-12 optically connected to the second optical output 601o2-8 of the eighth 2×2 optical coupler 601-8. In this manner the twelfth 2×2 optical coupler 601-12 receives the four CW laser light wavelengths λ₁, λ₂, λ₃, and λ₄ on the first optical input 601i1-12, and receives the four CW laser light wavelengths A₅, λ₆, λ₇, and λ₈ on the second optical input 601i2-12. The twelfth 2×2 optical coupler 601-12 has a first optical output 601o1-12 and a second optical output 601o2-12. The twelfth 2×2 optical coupler 601-12 is configured to combine all of the CW laser light wavelengths received on the first optical input 601i1-12 and the second optical input 601i2-12 onto each of the two optical outputs 601o1-12 and 601o2-12. In this manner, each of the eight CW laser light wavelengths λ₁, λ₂, λ₃, λ₄, λ₅, λ₆, λ₇, and λ₈ is output through each of the first optical output 601o1-12 and the second optical output 601o2-12 of the twelfth 2×2 optical coupler 601-12, which correspond to the optical outputs 311-7 and 311-8, respectively, of the 8×8 optical distribution network 600.

The 8×8 star coupler 307B also includes two more optical waveguide crossings 603-7 and 603-8 to enable optical routings between optical outputs of the 2×2 optical couplers 601-5 to 601-8 and optical inputs of the 2×2 optical couplers 601-9 to 601-12. The optical waveguide crossing 603-7 enables optical routing between the first optical output 601o1-6 of the sixth 2×2 optical coupler 601-6 and the second optical input 601i2-9 of the ninth 2×2 optical coupler 601-9. The optical waveguide crossing 603-7 also enables optical routing between the second optical output 601o2-5 of the fifth 2×2 optical coupler 601-5 and the first optical input 601i1-10 of the tenth 2×2 optical coupler 601-10. The optical waveguide crossing 603-8 enables optical routing between the first optical output 601o1-8 of the eighth 2×2 optical coupler 601-8 and the second optical input 601i2-11 of the eleventh 2×2 optical coupler 601-11. The optical waveguide crossing 603-8 also enables optical routing between the second optical output 601o2-7 of the seventh 2×2 optical coupler 601-7 and the first optical input 601i1-12 of the twelfth 2×2 optical coupler 601-12. Each of the optical waveguide crossings 603-7 and 603-8 is configured to ensure that CW laser light traveling through each of two crossing optical waveguides does not interfere with each other.

In various embodiments, the optical waveguide crossings 409 and 603-1 to 603-8 referred to herein can be implemented in many different ways, such as those described in the following references, by way of example, each of which is incorporated herein by reference: A) Y. Zhang et al., “A CMOS-Compatible, Low-Loss, and Low-Crosstalk Silicon Waveguide Crossing,” in IEEE Photonics Technology Letters, Vol. 25, No. 5, pp. 422-425, Mar. 1, 2013; B) H. Chen et al., “Low-Loss Multimode-Interference-Based Crossings for Silicon Wire Waveguides,” in IEEE Photonics Technology Letters, Vol. 18, No. 21, pp. 2260-2262, Nov. 1, 2006; C) H. Yang et al., “A Broadband, Low-Crosstalk and Low Polarization Dependent Silicon Nitride Waveguide Crossing Based on the Multimode-Interference,” Optics Communications, Vol. 450, pp. 28-33, 2019; D) P. Sanchis et al., “Highly Efficient Crossing Structure for Silicon-on-Insulator Waveguides,” Optics Letters, Vol. 34, pp. 2760-2762, 2009; E) W. Bogaerts et al., “Low-Loss, Low-Cross-Talk Crossings for Silicon-on-Insulator Nanophotonic Waveguides,” Optics Letters, Vol. 32, pp. 2801-2803, 2007; and F) C. H. Chen et al., “Taper-Integrated Multimode-Interference Based Waveguide Crossing Design,” in IEEE Journal of Quantum Electronics, Vol. 46, No. 11, pp. 1656-1661, November 2010.

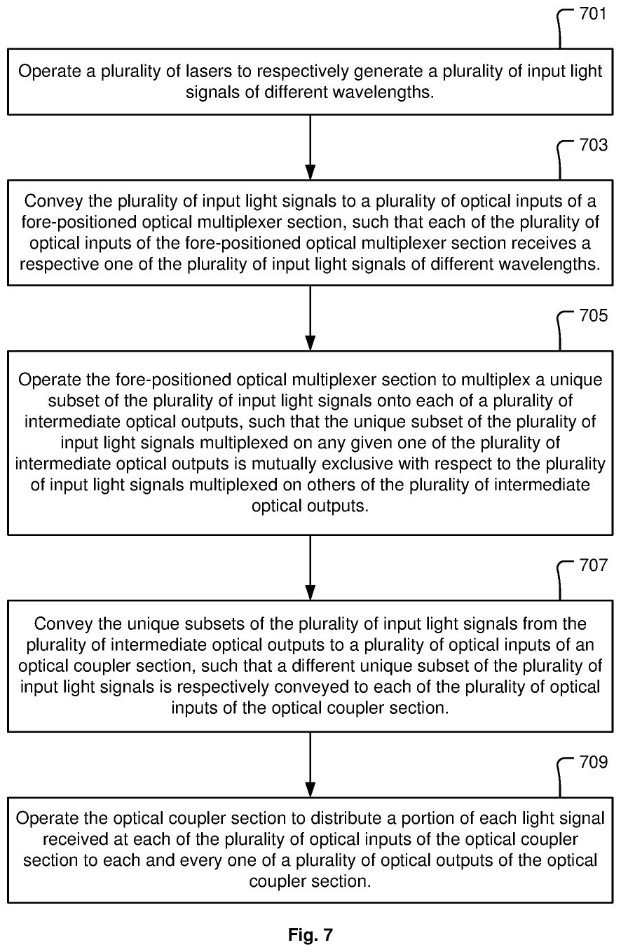

FIG. 7 shows a flowchart of a method for operating the laser module 500, in accordance with some embodiments. The method includes an operation 701 for operating a plurality of lasers (Laser 1 to Laser M) to respectively generate a plurality of input light signals of different wavelengths (λ₁ to λ_{M}). The method also includes an operation 703 for conveying the plurality of input light signals to the plurality of optical inputs (303i1-1-m and 303i2-1-m, where m is 1 to (M/2)) of the fore-positioned optical multiplexer section 313, such that each of the plurality of optical inputs (303i1-1-m and 303i2-1-m, where m is 1 to (M/2)) of the fore-positioned optical multiplexer section 313 receives a respective one of the plurality of input light signals of different wavelengths (λ₁ to λ_{M}). The method also includes an operation 705 for operating the fore-positioned optical multiplexer section 313 to multiplex a unique subset of the plurality of input light signals onto each of the plurality of intermediate optical outputs (305-1 to 305-O), such that the unique subset of the plurality of input light signals multiplexed on any given one of the plurality of intermediate optical outputs (305-1 to 305-O) is mutually exclusive with respect to the plurality of input light signals multiplexed on others of the plurality of intermediate optical outputs (305-1 to 305-O). The method also includes an operation 707 for conveying the unique subsets of the plurality of input light signals from the plurality of intermediate optical outputs (305-1 to 305-0) to the plurality of optical inputs (309-1 to 309-O) of an optical coupler section 315, such that a different unique subset of the plurality of input light signals is respectively conveyed to each of the plurality of optical inputs (309-1 to 309-O) of the optical coupler section 315. The method also includes an operation 709 for operating the optical coupler section 315 to distribute a portion of each light signal received at each of the plurality of optical inputs (309-1 to 309-O) of the optical coupler section 315 to each and every one of the plurality of optical outputs (311-1 to 311-O) of the optical coupler section 315. In some embodiments, the optical coupler section 315 is implemented as a free-space optical star coupler. In some embodiments, the optical coupler section 315 is implemented as a network of two-by-two optical couplers.

In some embodiments, the plurality of lasers (Laser 1 to Laser M) are arranged in the laser array 101 such that a wavelength sequence of the plurality of input light signals of different wavelengths is non-monotonically ordered across the laser array 101 so as to match a corresponding non-monotonically ordered sequence of wavelength acceptance passbands across the plurality of optical inputs (303i1-1-m and 303i2-1-m, where m is 1 to (M/2)) of the fore-positioned optical multiplexer section 313. In some embodiments, both a non-monotonic ordering of the wavelength sequence of the plurality of input light signals across the laser array 101 and a corresponding non-monotonic ordering of wavelength acceptance passbands across the plurality of optical inputs (303i1-1-m and 303i2-1-m, where m is 1 to (M/2)) of the fore-positioned optical multiplexer section 313 are collectively defined so that a tolerance of the optical power at the optical outputs of the laser module 500 for temperature-induced wavelength variation is increased for each of the plurality of lasers (Laser 1 to Laser M) as compared with the tolerance of the optical power at the optical outputs of the laser module 500 for temperature-induced wavelength variation for each of the plurality of lasers (Laser 1 to Laser M) that exists with both a monotonic ordering of the wavelength sequence of the plurality of input light signals across the laser array 101 and a corresponding monotonic ordering of wavelength acceptance passbands across the plurality of optical inputs (303i1-1-m and 303i2-1-m, where m is 1 to (M/2)) of the fore-positioned optical multiplexer section 313. The tolerance of the optical power at the optical outputs of the laser module 500 refers to a tolerable impact of wavelength variation on the output optical power of the laser module 500 for each wavelength at each optical output port of the laser module 500. Temperature-induced wavelength variation for each of the plurality of lasers (Laser 1 to Laser M) is a contributor to variation in the output optical power of the laser module 500 for each wavelength at each optical output port of the laser module 500, where said variation in the output optical power at the optical outputs of the laser module 500 should be maintained within a specified acceptable power tolerance range.

In some embodiments, operating the fore-positioned optical multiplexer section 313 in the operation 705 includes conveying the plurality of input light signals as received at the plurality of optical inputs (303i1-1-m and 303i2-1-m, where m is 1 to (M/2)) of the fore-positioned optical multiplexer section 313 through the number (P) of optical multiplexer stages 301-1 to 301-P, where the number (P) is equal to a first value divided by a logarithm of two, where the first value is a logarithm of a second value, and where the second value is equal to the number (M) of the plurality of optical inputs (303i1-1-m and 303i2-1-m, where m is 1 to (M/2)) of the fore-positioned optical multiplexer section 313 divided by the number (O) of the plurality of intermediate optical outputs (305-1 to 305-O) of the fore-positioned optical multiplexer section 313, i.e., P=[log(M/O)/log(2)].

In some embodiments, each of the number (P) of optical multiplexer stages (301-1 to 301-P) includes a number (K_{S}) of two-to-one optical multiplexers 303-S-Y, where S is an integer sequence number of a given one of the number (P) of optical multiplexer stages (301-1 to 301-P) counting from a first one of the number (P) of optical multiplexer stages (301-1 to 301-P) to a last one of the number (P) of optical multiplexer stages (301-1 to 301-P), and where Y is a multiplexer number from 1 to (M/2^{P}) within the S-th one of the optical multiplexer stages (301-1 to 301-P). The first one of the number (P) of optical multiplexer stages (301-1 to 301-P) has optical inputs optically connected to the number (M) of the plurality of optical inputs (303i1-1-m and 303i2-1-m, where m is 1 to (M/2)) of the fore-positioned optical multiplexer section 313. The last one of the number (P) of optical multiplexer stages (301-1 to 301-P) has optical outputs optically connected to the number (O) of the plurality of intermediate optical outputs (305-1 to 305-O) of the fore-positioned optical multiplexer section 313. The number (K_{S}) is equal to the number (M) of the plurality of optical inputs (303i1-1-m and 303i2-1-m, where m is 1 to (M/2)) of the fore-positioned optical multiplexer section 313 divided by a value equal to 2^{S}. Each of the number (K_{S}) of two-to-one optical multiplexers 303-S-Y includes a first optical input, a second optical input, and an optical output. The method includes operating each of the number (K_{S}) of two-to-one optical multiplexers 303-S-Y to combine light signals received on its first and second optical inputs onto its optical output.

The foregoing description of the embodiments has been provided for purposes of illustration and description, and is not intended to be exhaustive or limiting. Individual elements or features of a particular embodiment are generally not limited to that particular embodiment, but, where applicable, are interchangeable and can be used in a selected embodiment, even if not specifically shown or described. In this manner, one or more features from one or more embodiments disclosed herein can be combined with one or more features from one or more other embodiments disclosed herein to form another embodiment that is not explicitly disclosed herein, but rather that is implicitly disclosed herein. This other embodiment may also be varied in many ways. Such embodiment variations are not to be regarded as a departure from the disclosure herein, and all such embodiment variations and modifications are intended to be included within the scope of the disclosure provided herein.

Although some method operations may be described in a specific order herein, it should be understood that other housekeeping operations may be performed in between method operations, and/or method operations may be adjusted so that they occur at slightly different times or simultaneously or may be distributed in a system which allows the occurrence of the processing operations at various intervals associated with the processing, as long as the processing of the method operations are performed in a manner that provides for successful implementation of the method.

Although the foregoing embodiments have been described in some detail for purposes of clarity of understanding, it will be apparent that certain changes and modifications can be practiced within the scope of the appended claims. Accordingly, the embodiments disclosed herein are to be considered as illustrative and not restrictive, and are therefore not to be limited to just the details given herein, but may be modified within the scope and equivalents of the appended claims.

What is claimed is:

1. An optical distribution network, comprising:
a fore-positioned optical multiplexer section having a plurality of optical inputs and a plurality of intermediate optical outputs, each of the plurality of optical inputs of the fore-positioned optical multiplexer section configured to receive a respective one of a plurality of input light signals of different wavelengths, the fore-positioned optical multiplexer section configured to multiplex a unique subset of the plurality of input light signals onto each of the plurality of intermediate optical outputs, wherein the unique subset of the plurality of input light signals multiplexed on any given one of the plurality of intermediate optical outputs is mutually exclusive with respect to the plurality of input light signals multiplexed on others of the plurality of intermediate optical outputs; and
an optical coupler section having a plurality of optical inputs respectively optically connected to the plurality of intermediate optical outputs of the fore-positioned optical multiplexer section, the optical coupler section having a plurality of optical outputs corresponding to a plurality of optical outputs of the optical distribution network, the optical coupler section configured to distribute a portion of each light signal received at each of the plurality of optical inputs of the optical coupler section to each and every one of the plurality of optical outputs of the optical coupler section.

2. The optical distribution network as recited in claim 1, wherein the fore-positioned optical multiplexer section includes a number (P) of optical multiplexer stages, wherein the number (P) is equal to a first value divided by a logarithm of two, wherein the first value is a logarithm of a second value, and wherein the second value is equal to a number (M) of the plurality of optical inputs of the fore-positioned optical multiplexer section divided by a number (O) of the plurality of intermediate optical outputs of the fore-positioned optical multiplexer section.

3. The optical distribution network as recited in claim 2, wherein each of the number (P) of optical multiplexer stages includes a number (K_{S}) of two-to-one optical multiplexers, wherein (S) is an integer sequence number of a given one of the number (P) of optical multiplexer stages counting from a first one of the number (P) of optical multiplexer stages to a last one of the number (P) of optical multiplexer stages, wherein the first one of the number (P) of optical multiplexer stages has optical inputs optically connected to the number (M) of the plurality of optical inputs of the fore-positioned optical multiplexer section, wherein the last one of the number (P) of optical multiplexer stages has optical outputs optically connected to the number (O) of the plurality of intermediate optical outputs of the fore-positioned optical multiplexer section, and wherein the number (K_{S}) is equal to the number (M) of the plurality of optical inputs of the fore-positioned optical multiplexer section divided by a value equal to 2^{S}.

4. The optical distribution network as recited in claim 3, wherein each of the number (K_{S}) of two-to-one optical multiplexers includes a first optical input, a second optical input, and an optical output, and wherein each of the number (K_{S}) of two-to-one optical multiplexers is configured to combine light signals received on its first and second optical inputs onto its optical output.

5. The optical distribution network as recited in claim 4, wherein each of a number (K₁) of two-to-one optical multiplexers in a first optical multiplexer stage of the number (P) of optical multiplexer stages is configured to have a first optical wavelength passband for its first optical input and a second optical wavelength passband for its second optical input, wherein the second optical wavelength passband is different than the first optical wavelength passband.

6. The optical distribution network as recited in claim 5, wherein the first optical wavelength passband and the second optical wavelength passband correspond to non-sequential channel wavelengths of continuous wave laser light input to the optical distribution network.

7. The optical distribution network as recited in claim 1, wherein the optical coupler section is implemented as a free-space optical star coupler.

8. The optical distribution network as recited in claim 1, wherein the optical coupler section is implemented as a network of two-by-two optical couplers.

9. A laser module, comprising:
a laser array including a plurality of lasers, wherein each laser of the plurality of lasers is configured to generate and output a different one of a plurality of wavelengths of continuous wave laser light, wherein the plurality of lasers are arranged in the laser array such that a sequence of the plurality of wavelengths of continuous wave laser light is non-monotonically ordered across the laser array; and
an optical distribution network including a fore-positioned optical multiplexer section and an optical coupler section disposed after the fore-positioned optical multiplexer section with respect to a light propagation direction through the optical distribution network, wherein the fore-positioned optical multiplexer section has a plurality of optical inputs optically connected to the plurality of lasers, such that the non-monotonic ordering of the sequence of the plurality of wavelengths of continuous wave laser light across the laser array matches an ordering of wavelength acceptance passbands of the plurality of optical inputs of the fore-positioned optical multiplexer section, wherein the fore-positioned optical multiplexer section has a plurality of intermediate optical outputs, wherein the fore-positioned optical multiplexer section is configured to multiplex a unique and mutually exclusive subset of the plurality of wavelengths of continuous wave laser light onto each of the plurality of intermediate optical outputs, wherein the optical coupler section has a plurality of optical inputs respectively optically connected to the plurality of intermediate optical outputs of the fore-positioned optical multiplexer section, wherein the optical coupler section has a plurality of optical outputs respectively corresponding to each of a plurality of optical outputs of the optical distribution network and a plurality of outputs of the laser module, wherein the optical coupler section is configured to distribute a portion of each light signal received at each of the plurality of optical inputs of the optical coupler section to each and every one of the plurality of optical outputs of the optical coupler section.

10. The laser module as recited in claim 9, wherein the plurality of lasers are thermally interfaced with a common thermally conductive substrate.

11. The laser module as recited in claim 9, wherein the laser array is optically interfaced with the optical distribution network such that the plurality of wavelengths of continuous wave laser light are transmitted directly from the plurality of lasers into the plurality of optical inputs of the fore-positioned optical multiplexer section.

12. The laser module as recited in claim 9, wherein the fore-positioned optical multiplexer section includes a number (P) of optical multiplexer stages, wherein the number (P) is equal to a first value divided by a logarithm of two, wherein the first value is a logarithm of a second value, and wherein the second value is equal to a number (M) of the plurality of optical inputs of the fore-positioned optical multiplexer section divided by a number (O) of the plurality of intermediate optical outputs of the fore-positioned optical multiplexer section.

13. The laser module as recited in claim 12, wherein each of the number (P) of optical multiplexer stages includes a number (K_{S}) of two-to-one optical multiplexers, wherein S is an integer sequence number of a given one of the number (P) of optical multiplexer stages counting from a first one of the number (P) of optical multiplexer stages to a last one of the number (P) of optical multiplexer stages, wherein the first one of the number (P) of optical multiplexer stages has optical inputs optically connected to the number (M) of the plurality of optical inputs of the fore-positioned optical multiplexer section, wherein the last one of the number (P) of optical multiplexer stages has optical outputs optically connected to the number (O) of the plurality of intermediate optical outputs of the fore-positioned optical multiplexer section, and wherein the number (K_{S}) is equal to the number of the number (M) of the plurality of optical inputs of the fore-positioned optical multiplexer section divided by a value equal to 2^{S}.

14. The laser module as recited in claim 13, wherein each of the number (K_{S}) of two-to-one optical multiplexers includes a first optical input, a second optical input, and an optical output, and wherein each of the number (K_{S}) of two-to-one optical multiplexers is configured to combine light signals received on its first and second optical inputs onto its optical output.

15. The laser module as recited in claim 14, wherein each of a number (K₁) of two-to-one optical multiplexers in the first one of the number (P) of optical multiplexer stages is configured to have a first optical wavelength passband for its first optical input and a second optical wavelength passband for its second optical input, wherein the second optical wavelength passband is different than the first optical wavelength passband.

16. A method for operating a laser module, comprising:
operating a plurality of lasers to respectively generate a plurality of input light signals of different wavelengths;
conveying the plurality of input light signals to a plurality of optical inputs of a fore-positioned optical multiplexer section, such that each of the plurality of optical inputs of the fore-positioned optical multiplexer section receives a respective one of the plurality of input light signals of different wavelengths;
operating the fore-positioned optical multiplexer section to multiplex a unique subset of the plurality of input light signals onto each of a plurality of intermediate optical outputs, such that the unique subset of the plurality of input light signals multiplexed on any given one of the plurality of intermediate optical outputs is mutually exclusive with respect to the plurality of input light signals multiplexed on others of the plurality of intermediate optical outputs;
conveying the unique subsets of the plurality of input light signals from the plurality of intermediate optical outputs to a plurality of optical inputs of an optical coupler section, such that a different unique subset of the plurality of input light signals is respectively conveyed to each of the plurality of optical inputs of the optical coupler section; and
operating the optical coupler section to distribute a portion of each light signal received at each of the plurality of optical inputs of the optical coupler section to each and every one of a plurality of optical outputs of the optical coupler section.

17. The method as recited in claim 16, wherein the plurality of lasers are arranged in a laser array such that a wavelength sequence of the plurality of input light signals of different wavelengths is non-monotonically ordered across the laser array so as to match a corresponding non-monotonically ordered sequence of wavelength acceptance passbands across the plurality of optical inputs of the fore-positioned optical multiplexer section.

18. The method as recited in claim 17, wherein both a non-monotonic ordering of the wavelength sequence of the plurality of input light signals across the laser array and a corresponding non-monotonic ordering of wavelength acceptance passbands across the plurality of optical inputs of the fore-positioned optical multiplexer section are collectively defined so that a tolerance on optical power at the plurality of optical outputs of the optical coupler section for temperature-induced wavelength variation is increased for each of the plurality of lasers as compared with the tolerance on optical power at the plurality of optical outputs of the optical coupler section for temperature-induced wavelength variation for each of the plurality of lasers that exists with both a monotonic ordering of the wavelength sequence of the plurality of input light signals across the laser array and a corresponding monotonic ordering of wavelength acceptance passbands across the plurality of optical inputs of the fore-positioned optical multiplexer section.

19. The method as recited in claim 16, wherein operating the fore-positioned optical multiplexer section includes conveying the plurality of input light signals as received at the plurality of optical inputs of the fore-positioned optical multiplexer section through a number (P) of optical multiplexer stages, wherein the number (P) is equal to a first value divided by a logarithm of two, wherein the first value is a logarithm of a second value, and wherein the second value is equal to a number (M) of the plurality of optical inputs of the fore-positioned optical multiplexer section divided by a number (O) of the plurality of intermediate optical outputs of the fore-positioned optical multiplexer section.

20. The method as recited in claim 19, wherein each of the number (P) of optical multiplexer stages includes a number (K_{S}) of two-to-one optical multiplexers, wherein S is an integer sequence number of a given one of the number (P) of optical multiplexer stages counting from a first one of the number (P) of optical multiplexer stages to a last one of the number (P) of optical multiplexer stages, wherein the first one of the number (P) of optical multiplexer stages has optical inputs optically connected to the number (M) of the plurality of optical inputs of the fore-positioned optical multiplexer section, wherein the last one of the number (P) of optical multiplexer stages has optical outputs optically connected to the number (O) of the plurality of intermediate optical outputs of the fore-positioned optical multiplexer section, and wherein the number (K_{S}) is equal to the number (M) of the plurality of optical inputs of the fore-positioned optical multiplexer section divided by a value equal to 2^{S}.

21. The method as recited in claim 20, wherein each of the number (K_{S}) of two-to-one optical multiplexers includes a first optical input, a second optical input, and an optical output, and wherein the method includes operating each of the number (K_{S}) of two-to-one optical multiplexers to combine light signals received on its first and second optical inputs onto its optical output.

22. The method as recited in claim 16, wherein the optical coupler section is implemented as a free-space optical star coupler.

23. The method as recited in claim 16, wherein the optical coupler section is implemented as a network of two-by-two optical couplers.
